(19) United States
(12) Patent Application Publication
(10) Pub. No.: US 2025/0088320 A1
(43) Pub. Date: Mar. 13, 2025

(54) HOPPING MONITORING CONFIGURATION FOR RADIO FREQUENCY (RF) SENSING AND POSITIONING

(71) Applicant: QUALCOMM Incorporated, San Diego, CA (US)

(72) Inventors: Marwen Zorgui, San Diego, CA (US); Srinivas Yerramalli, San Diego, CA (US); Xiaoxia Zhang, San Diego, CA (US); Mohammed Ali Mohammed Hirzallah, San Diego, CA (US)

(21) Appl. No.: 18/466,353

(22) Filed: Sep. 13, 2023

(51) Int. Cl. H04L 5/00

(52) U.S. Cl. CPC H04L 5/0012; H04L 5/0048

(57) ABSTRACT

This disclosure provides systems, methods, and devices for wireless communication that support hopping monitoring operation. According to some aspects, hopping monitoring configuration provides for sub-band baseband bandwidth hopping, antenna resource hopping, or combinations thereof. In operation according to some aspects, wireless communication devices may provide information regarding capability of the UE for baseband frequency hopping. Other aspects and features are also claimed and described.

### TECHNICAL FIELD

Aspects of the present disclosure relate generally to wireless communication systems, and more particularly, to hopping monitoring configuration, such as for radio frequency (RF) sensing, positioning, etc. Some features may enable and provide improved communications, including hopping monitoring configuration providing for sub-band baseband bandwidth hopping, antenna resource hopping, or combinations thereof.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as network nodes (or node Bs) that may support communication for a number of user equipments (UEs). A UE may communicate with a network node via downlink and uplink. The downlink (or forward link) refers to the communication link from the network node to the UE, and the uplink (or reverse link) refers to the communication link from the UE to the network node.

A network node may transmit data and control information on a downlink to a UE or may receive data and control information on an uplink from the UE. On the downlink, a transmission from the network node may encounter interference due to transmissions from neighbor network nodes or from other wireless radio frequency (RF) transmitters. On the uplink, a transmission from the UE may encounter interference from uplink transmissions of other UEs communicating with the neighbor network nodes or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

The use of RF sensing, for example, is being explored with respect to facilitate various aspects of monitoring, maintaining, and controlling wireless communication networks. RF sensing of some examples may utilize dedicated frequency and time domain resources for sensing operations. In operation, RF signals may be broadcast for utilization in detecting, monitoring, and/or tracking (e.g., determining location, velocity, etc.) of multiple wireless communication devices (e.g., UEs), monitor and/or detect changes in the wireless communication environment, etc.

Orthogonal frequency division multiplexing (OFDM) waveforms have been considered for RF sensing due to their robustness to channel fading and multipath propagation. For example, OFDM signals may attractive for RF sensing in light of advantages with respect to the field of angle estimation with multiple input, multiple output (MIMO) operations and absence of range-Doppler coupling as it occurs for linear frequency modulated waveforms, despite disadvantages with respect to peak-to-average power ratio (PAPR). However, OFDM waveforms for RF sensing may occupy a relatively large baseband bandwidth (e.g., 1-5 GHZ), and a wireless communication device may need to sample the whole RF bandwidth of the OFDM waveform in RF sensing operation. For example, a bandwidth of 3 GHZ may need to be sampled to provide RF sensing for 5 cm range resolution. Various wireless communication devices, such as some UE implementations, may have hardware configurations (e.g., analog to digital converter (ADC)), power utilization considerations (e.g., low power mode operation), etc. that present issues with respect to sampling relatively large baseband bandwidth signals.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a user equipment (UE) includes a processing system that includes one or more processors and one or more memories coupled with the one or more processors. The processing system of examples is configured to cause the UE to obtain, from a network configuring entity, an indication of a hopping monitoring configuration for a reference signal; and configure processing for the reference signal according to the indication of the hopping monitoring configuration.

In an additional aspect of the disclosure, a method for wireless communication includes obtaining, by the UE from a network configuring entity, an indication of a hopping monitoring configuration for a reference signal; and configuring, by the UE, processing for the reference signal according to the indication of the hopping monitoring configuration.

In an additional aspect of the disclosure, a UE includes means for obtaining, by the UE from a network configuring entity, an indication of a hopping monitoring configuration for a reference signal; and means for configuring, by the UE, processing for the reference signal according to the indication of the hopping monitoring configuration.

In an additional aspect of the disclosure, a non-transitory computer-readable medium stores instructions that, when executed by a processor, cause the processor to perform operations. The operations include obtaining, by the UE from a network configuring entity, an indication of a hopping monitoring configuration for a reference signal; and means for configuring, by the UE, processing for the reference signal according to the indication of the hopping monitoring configuration.

In one aspect of the disclosure, a network configuration element includes a processing system that includes one or more processors and one or more memories coupled with the one or more processors. The processing system of examples is configured to cause the network configuration element to determine a hopping monitoring configuration for a reference signal; and provide, for one or more user equipments (UEs), an indication of the hopping monitoring configuration.

In an additional aspect of the disclosure, a method for wireless communication includes determining a hopping monitoring configuration for a reference signal; and providing, for one or more user equipments (UEs), an indication of the hopping monitoring configuration.

In an additional aspect of the disclosure, a network configuration element includes means for determining a hopping monitoring configuration for a reference signal; and means for providing, for one or more user equipments (UEs), an indication of the hopping monitoring configuration.

In an additional aspect of the disclosure, a non-transitory computer-readable medium stores instructions that, when executed by a processor, cause the processor to perform operations. The operations include determining a hopping monitoring configuration for a reference signal; and providing, for one or more user equipments (UEs), an indication of the hopping monitoring configuration.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a network node and a user equipment (UE) according to one or more aspects.

FIG. 3 is a block diagram illustrating an example wireless communication system that supports hopping monitoring configuration according to one or more aspects.

FIGS. 4A and 4B show sub-band baseband bandwidth hopping configurations as may be provided by a hopping monitoring configuration according to one or more aspects.

FIG. 5 shows a sub-band baseband bandwidth hopping configuration as may be provided by a hopping monitoring configuration according to one or more aspects.

FIG. 6 shows use of a plurality of antenna beams according to one or more aspects.

FIGS. 7 and 8 are flow diagrams illustrating example processes that support hopping monitoring configuration according to one or more aspects.

FIG. 9 is a block diagram of an example network configuring entity that supports hopping monitoring configuration according to one or more aspects.

FIG. 10 is a block diagram of an example UE that supports hopping monitoring configuration according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support hopping monitoring configurations for reference signals, such as for radio frequency (RF) sensing, positioning, etc. According to some examples, hopping monitoring configuration provides for sub-band baseband bandwidth hopping, antenna resource hopping, or combinations thereof.

An example sub-band baseband bandwidth hopping configuration provides a relatively low baseband bandwidth configuration. For example, a uniform sub-band frequency hopping pattern may be provided in which uniform sub-bands of a reference signal bandwidth are sampled by one or more wireless communication devices (e.g., user equipment (UE)) in RF sensing operation. In another example, a non-uniform sub-band frequency hopping pattern may be provided in which non-uniform sub-bands of a reference signal bandwidth are sampled by a wireless communication device in RF sensing operation. In operation according to some examples, wireless communication devices may provide information regarding capability of the UE for baseband frequency hopping, such as for use by a network configuring entity in providing hopping monitoring configurations.

An example antenna resource hopping configuration provides an extension of angular maps. For example, an antenna resource hopping configuration may include a subset of antenna resources (e.g., antennas, antenna elements, antenna ports, etc.) for use by one or more wireless communication devices (e.g., UE) in RF sensing operation, such as may differ from antenna resources used in monitoring one or more other signals (e.g., control signals, data signals, etc.). According to some examples, an antenna resource hopping configuration may provide a pattern of subsets of antenna resources for use by one or more wireless communication devices (e.g., UE) on a per orthogonal frequency division multiplexing (OFDM) symbol or sub-band basis in RF sensing operation.

Particular implementations of the subject matter described in this disclosure may be implemented to realize one or more of the following potential advantages or benefits. In some aspects, the present disclosure provides techniques for signaling enabling configuration of low baseband bandwidth for RF sensing and positioning operations in wireless communication networks. In operation according to some examples, high range resolution associated with a large RF bandwidth is supported using lower baseband bandwidth for sampling a reference signal. Wireless communication device implementations using or having reduced hardware resources (e.g., relatively slow analog to digital converter (ADC)), power utilization (e.g., low power mode operation), etc. may be supported according to aspects of the disclosure. According to some examples in which a uniform sub-band frequency hopping pattern is provided with respect to a sub-band baseband bandwidth hopping configuration of a hopping monitoring configuration, high range position resolution may be supported by RF sensing operation with similar wireless communication device complexity as used in more typical OFDM operations. According to some examples in which a non-uniform sub-band frequency hopping pattern is provided with respect to a sub-band baseband bandwidth hopping configuration of a hopping monitoring configuration, higher effective signal to noise ratio (SNR) is provided and construction of equivalent standard full OFDM scheme is facilitated with low baseband bandwidth transmissions. According to some examples in which antenna resource hopping is provided with respect to a hopping monitoring configuration, wireless communication device power saving is provided (e.g., a UE may use a smaller number of antennas in RF sensing operation).

As should be appreciated from the foregoing, this disclosure relates generally to providing or participating in authorized shared access between two or more wireless communication devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the network nodes (for example, the Ater and Abis interfaces) and the network node controllers (A interfaces, etc.). The radio access network represents a component of a GSM network, through which phone calls and packet data are routed from and to the public switched telephone network (PSTN) and Internet to and from subscriber handsets, also known as user terminals or UEs. A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜ 1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHZ-7.125 GHZ) and FR2 (24.25 GHz-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHZ-300 GHz) which is identified by the International Telecommunications Union (ITU) as a “mm Wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHz, and the like bandwidth. For other various outdoor and small cell coverage deployments of TDD greater than 3 GHZ, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

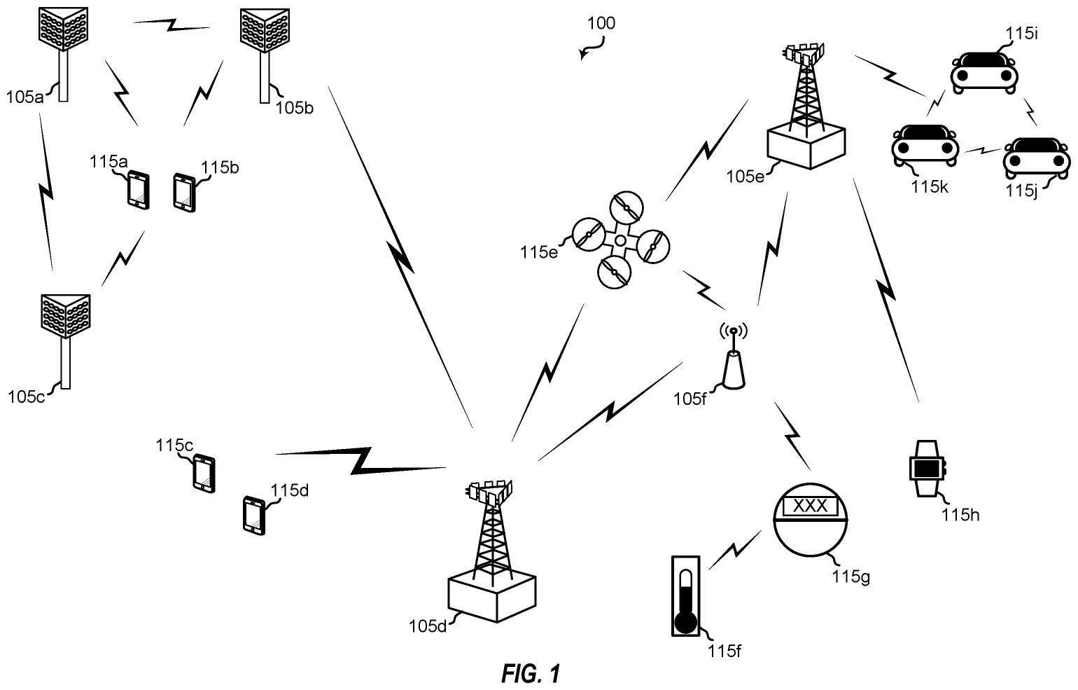

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of network nodes 105 and other network entities. Some instances of a network node may be a station that communicates with the UEs and may also be referred to as a base station, an evolved node B (eNB), a next generation eNB (gNB), an access point, and the like. Each network node 105 may provide communication coverage for a particular geographic area. In 3GPP, the term “cell” may refer to this particular geographic coverage area of a network node or a network node subsystem serving the coverage area, depending on the context in which the term is used. In implementations of wireless network 100 herein, network nodes 105 may be associated with a same operator or different operators (e.g., wireless network 100 may include a plurality of operator wireless networks). Additionally, in implementations of wireless network 100 herein, network node 105 may provide wireless communications using one or more of the same frequencies (e.g., one or more frequency bands in licensed spectrum, unlicensed spectrum, or a combination thereof) as a neighboring cell. In some examples, an individual network node 105 or UE 115 may be operated by more than one network operating entity. In some other examples, each network node 105 and UE 115 may be operated by a single network operating entity.

A network node may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A network node for a macro cell may be referred to as a macro base station. A network node for a small cell may be referred to as a small cell base station, a pico base station, a femto base station or a home base station. In the example shown in FIG. 1, network nodes 105d and 105e are regular macro base stations, while network nodes 105a-105c are macro base stations enabled with one of 3 dimension (3D), full dimension (FD), or massive MIMO. Network nodes 105a-105c take advantage of their higher dimension MIMO capabilities to exploit 3D beamforming in both elevation and azimuth beamforming to increase coverage and capacity. Network node 105f is a small cell base station which may be a home node or portable access point. A network node may support one or multiple (e.g., two, three, four, and the like) cells.

Wireless network 100 may support synchronous or asynchronous operation. For synchronous operation, the network nodes may have similar frame timing, and transmissions from different network nodes may be approximately aligned in time. For asynchronous operation, the network nodes may have different frame timing, and transmissions from different network nodes may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the network nodes, whether macro base stations, pico base stations, femto base stations, relays, and the like. In FIG. 1, a communication link (represented as a lightning bolt) indicates wireless transmissions between a UE and a serving network node, which is a network node designated to serve the UE on the downlink or uplink, or desired transmission between network nodes, and backhaul transmissions between network nodes. UEs may operate as base stations or other network nodes in some scenarios. Backhaul communication between network nodes of wireless network 100 may occur using wired or wireless communication links.

In operation at wireless network 100, network nodes 105a-105c serve UEs 115a and 115b using 3D beamforming and coordinated spatial techniques, such as coordinated multipoint (CoMP) or multi-connectivity. Macro network node 105d performs backhaul communications with network nodes 105a-105c, as well as small cell, network node 105f. Macro network node 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro network nodes 105d and 105e, as well as small cell network node 105f. Other machine type devices, such as UE 115f (thermometer), UE 115g (smart meter), and UE 115h (wearable device) may communicate through wireless network 100 either directly with network nodes, such as small cell network node 105f, and macro network node 105e, or in multi-hop configurations by communicating with another user device which relays its information to the network, such as UE 115f communicating temperature measurement information to the smart meter, UE 115g, which is then reported to the network through small cell network node 105f. Wireless network 100 may also provide additional network efficiency through dynamic, low-latency TDD communications or low-latency FDD communications, such as in a vehicle-to-vehicle (V2V) mesh network between UEs 115i-115k communicating with macro network node 105c.

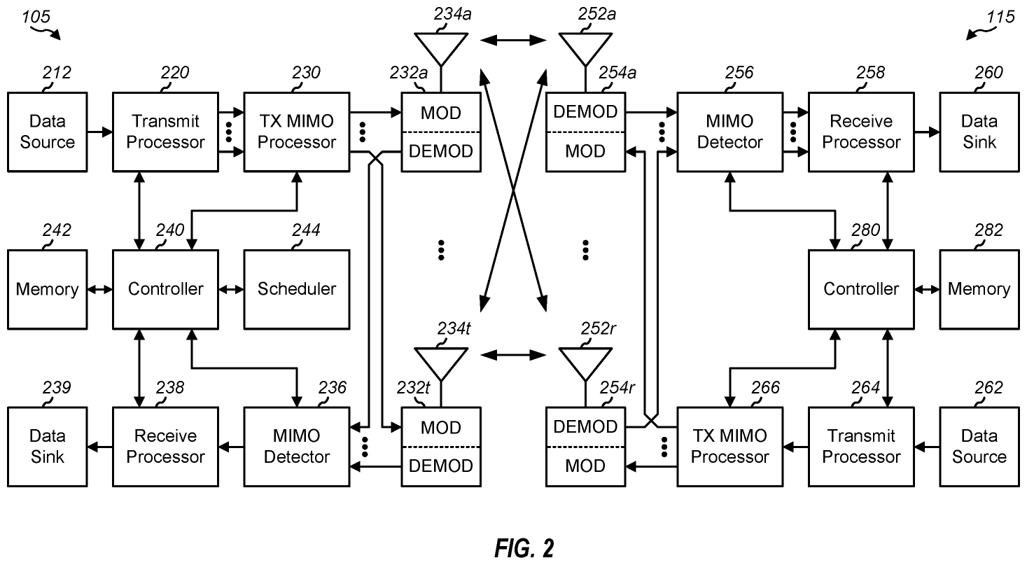

FIG. 2 is a block diagram illustrating examples of network node 105 and UE 115 according to one or more aspects. Network node 105 and UE 115 may be any of the network nodes and one of the UEs in FIG. 1. For a restricted association scenario (as mentioned above), network node 105 may be small cell network node 105f in FIG. 1, and UE 115 may be UE 115c or 115d operating in a service area of network node 105f, which in order to access small cell network node 105f, would be included in a list of accessible UEs for small cell network node 105f. Network node 105 may also be a network node of some other type. As shown in FIG. 2, network node 105 may be equipped with antennas 234a through 234t, and UE 115 may be equipped with antennas 252a through 252r for facilitating wireless communications.

At network node 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from network node 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to network node 105. At network node 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

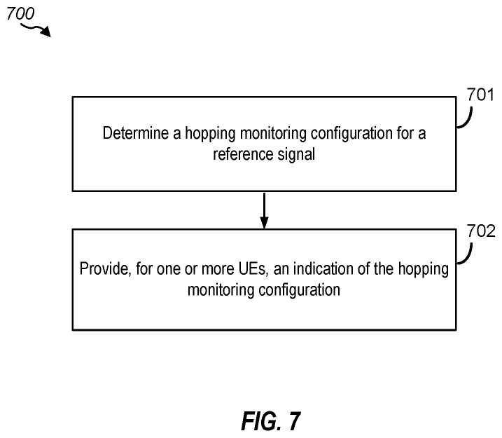

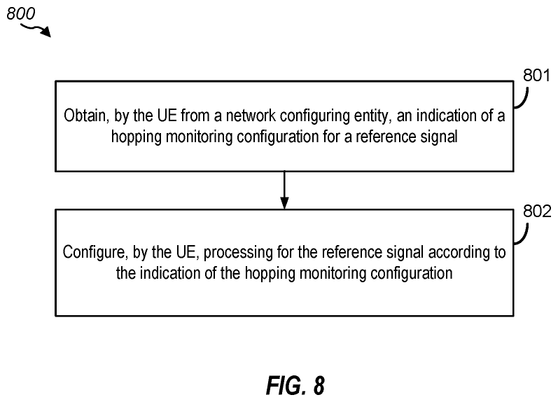

Controllers 240 and 280 may direct the operation at network node 105 and UE 115, respectively. Controller 240 or other processors and modules at network node 105 or controller 280 or other processors and modules at UE 115 may perform or direct the execution of various processes for the techniques described herein, such as to perform or direct the execution illustrated in FIGS. 7 and 8, or other processes for the techniques described herein. Memories 242 and 282 may store data and program codes for network node 105 and UE 115, respectively. Scheduler 244 may schedule UEs for data transmission on the downlink or the uplink.

RF sensing, also referred to as radio detection and ranging (RADAR), may be implemented in wireless network 100 to facilitate monitoring, maintaining, and/or controlling aspects of the wireless networks, wireless communication devices operating in the wireless network, or a combination thereof. In operation according to some examples, reference signals (e.g., sounding reference signal (SRS), positioning reference signal (PRS), etc.) may be broadcast for utilization in detecting, monitoring, and/or tracking (e.g., determining location, velocity, etc.) of one or more UEs 115, monitor and/or detect changes in the environment of wireless communication network 100, etc. One or more of UEs 115 may perform RF sensing with respect to a reference signal in accordance with hopping monitoring configuration information provided by one or more network configuring entities (e.g., one or more of network nodes 105), according to concepts of the present disclosure.

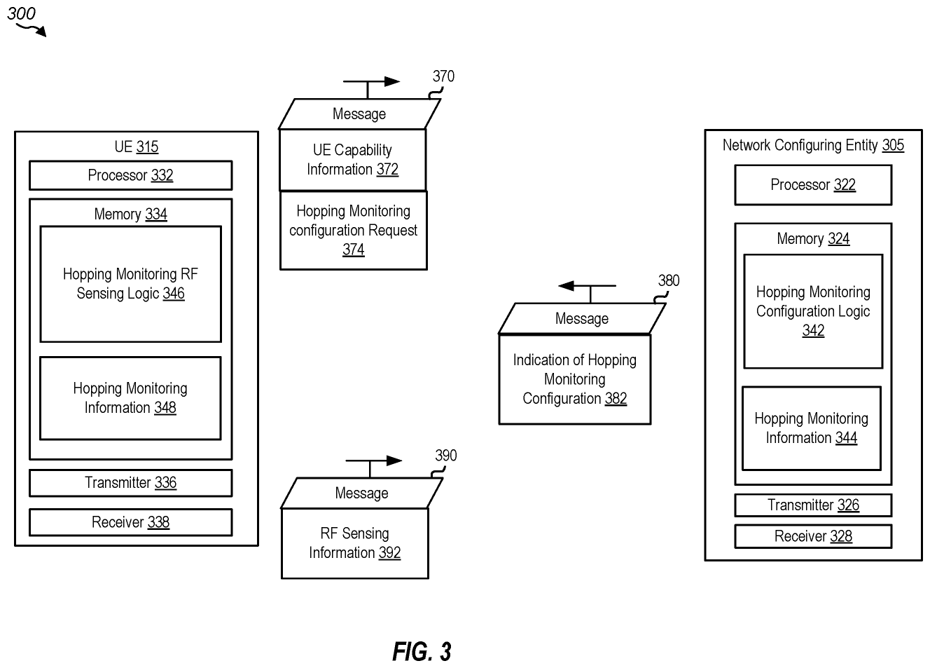

FIG. 3 is a block diagram of an example wireless communications system 300 that supports hopping monitoring configuration according to one or more aspects. In some examples, wireless communications system 300 may implement aspects of wireless network 100. Wireless communications system 300 includes UE 315 and network configuration entity 305. UE 315 of some examples may comprise or otherwise correspond to an instance of a UE of UEs 115 of FIGS. 1 and 2. Network configuring entity 305 of some examples may comprise or otherwise correspond to an instance of a network location management function (LMF), a network sensing management function (SnMF), a network node, etc. For example, network configuring entity 305 may comprise or otherwise correspond to an instance of a network node of network nodes 105 of FIGS. 1 and 2. A SnMF is a network entity that is responsible for managing and coordinating sensing sessions, and may be a standalone entity, part of a network node (e.g., base station), part of a LMF. Network configuring entity 305 of some examples may comprise logic and/or functionality (e.g., a SnMF and/or a LMF) aggregated or integrated with one or more network nodes (e.g., one or more of network nodes 105 of FIGS. 1 and 2). In accordance with some aspects, network configuring entity 305 may comprise a network element (e.g., a network element disposed in the network core implementing a SnMF and/or a LMF) separate or disaggregated from network nodes in wireless communication with UE 315. Accordingly, network configuring element 305 of some examples may obtain information from and/or provide information to UE 315 via one or more network nodes, such as may comprise instances of network nodes 105 of FIGS. 1 and 2. Network configuring entity 305 of some examples may comprise or otherwise correspond to a second UE (e.g., a UE of UEs 115 of FIGS. 1 and 2). For example, network configuring entity 305 may comprise or otherwise correspond to a UE in sidelink communication with UE 315. In accordance with some aspects, network configuring entity 305 may comprise a UE in the form of a roadside unit (RSU), an IoT device, etc. Although one UE 315 and one network configuring entity 305 are illustrated, in some other implementations, wireless communications system 300 may generally include multiple UEs 315, and may include more than one network configuring entity 305.

UE 315 may include a variety of components (such as structural, hardware components) used for carrying out one or more functions described herein. For example, these components may include a processing system that includes one or more processors 332 and one or more memories 334 (hereinafter referred to collectively as “memory 334”) coupled with the one or more processors 332 (hereinafter referred to collectively as “processor 332”). The components of UE 315 may further include one or more transmitters 336 (hereinafter referred to collectively as “transmitter 316”) and one or more receivers 338 (hereinafter referred to collectively as “receiver 338”). Processor 332 may be configured to execute instructions stored in memory 334 to perform the operations described herein. In some implementations, processor 332 includes or corresponds to one or more of receive processor 258, transmit processor 264, and controller 280, and memory 334 includes or corresponds to memory 282.

Memory 334 of the example of FIG. 3 includes or is configured to store hopping monitoring RF sensing logic 346 and hopping monitoring information 346. Hopping monitoring RF sensing logic 346 may be configured to provide functionality at UE 315 for hopping monitoring configuration operation, such as for implementing RF sensing, positioning, etc. by UE 315, according to concepts herein. Hopping monitoring RF sensing logic 346 of some examples may access, utilize, store, update, etc. data of hopping monitoring information 348 for implementing various aspects of hopping monitoring configuration operation.

Transmitter 336 of the illustrated example is configured to transmit reference signals, control information, and data to one or more other devices, and receiver 338 of the illustrated example is configured to receive references signals, synchronization signals, control information, and data from one or more other devices. For example, transmitter 336 may transmit signaling, control information, and data to, and receiver 338 may receive signaling, control information, and data from, network configuring entity 305. In some implementations, transmitter 336 and receiver 338 may be integrated in one or more transceivers. Additionally or alternatively, transmitter 336 and/or receiver 338 may include or correspond to one or more components of UE 115 described with reference to FIG. 2.

Network configuring entity 305 may include a variety of components (such as structural, hardware components) used for carrying out one or more functions described herein. For example, these components may include a processing system that includes one or more processors 322 and one or more memories 324 (hereinafter referred to collectively as “memory 324”) coupled with the one or more processors 322 (hereinafter referred to collectively as “processor 322”). The components of network configuring entity 305 may further include one or more transmitters 326 (hereinafter referred to collectively as “transmitter 326”), and one or more receivers 328 (hereinafter referred to collectively as “receiver 328”). Processor 322 may be configured to execute instructions stored in memory 324 to perform the operations described herein. In some implementations, processor 322 includes or corresponds to one or more of receive processor 238, transmit processor 220, and controller 240, and memory 324 includes or corresponds to memory 242.

Memory 324 of the example of FIG. 3 includes or is configured to store hopping monitoring configuration logic 342 and hopping monitoring information 344. Hopping monitoring configuration logic 342 may be configured to provide functionality at network configuring entity 305 for hopping monitoring configuration operation, such as for initiating, controlling, managing, etc. RF sensing, positioning, etc. at UE 315, according to concepts herein. Hopping monitoring configuration logic 326 of some examples may access, utilize, store, update, etc. data of hopping monitoring information 344 for implementing various aspects of hopping monitoring configuration operation.

Transmitter 326 of the illustrated example is configured to transmit reference signals, synchronization signals, control information, and data to one or more other devices, and receiver 328 of the illustrated example is configured to receive reference signals, control information and data from one or more other devices. For example, transmitter 326 may transmit signaling, control information, and data to, and receiver 328 may receive signaling, control information, and data from, UE 315. In some implementations, transmitter 326 and receiver 328 may be integrated in one or more transceivers. Additionally or alternatively, transmitter 326 or receiver 328 may include or correspond to one or more components of network node 105 described with reference to FIG. 2.

In some implementations, wireless communications system 300 implements a 5G NR network. For example, wireless communications system 300 may include multiple 5G-capable UEs 315 and multiple 5G-capable network configuration entities 305, such as UEs and network nodes configured to operate in accordance with a 5G NR network protocol such as that defined by the 3GPP standards.

During operation of wireless communications system 300 of the illustrated example, UE 315 may communicate one or messages 370 to network configuring entity 305, such as to facilitate hopping monitoring configuration, to request hopping monitoring configuration operation, etc. UE 315 may, for example, transmit one or more messages 370 via transmitter 336 operating under control of hopping monitoring RF sensing logic 346 according to some aspects. In an example in which network configuring entity 305 comprises a network node in wireless communication with UE 315, message 370 may be transmitted directly to network configuring entity 305 by UE 315. In an example, in which network configuring entity 305 is not in wireless communication with UE 315 (e.g., network configuring entity 305 comprises a network element disposed in the network core implementing a LMF or a SnMF separate from network nodes in wireless communication with UE 315), message 370 may be transmitted to network configuring entity 305 by UE 315 via a network node (e.g., a network node of network nodes 105) in wireless communication with UE 315.

According to some aspects, UE 315 may provide capability signaling using one or more messages 370. In hopping monitoring configuration operation according to an example, UE 315 indicates its capability to do baseband frequency hopping (e.g., to a network node in communication with the UE, a LMF, a SnMF, another UE, etc.) using an instance of message 370. Accordingly, message 370 may include UE capability information 372, such as may include one or more UE capability indication regarding baseband frequency hopping capability. In operation according to some examples, UE capability information 372 may be provided based on a request (not shown) from a device of wireless communication system 300 (e.g., a network node in communication with the UE, a LMF, a SnMF, another UE, etc.).

UE capability information 372 of some information may provide information useful in determining aspects of a hopping monitoring configuration for implementation by UE 315. According to some examples, UE capability information 372 may indicate a minimum time needed by UE 315 to do frequency hopping between two transmissions, a minimum time needed by UE 315 to do frequency hopping between two receptions, or a combination thereof. UE capability information 372 may include the data specifying UE baseband frequency hopping capability (e.g., data of hopping monitoring information 348), an index or other indicator of data regarding UE baseband frequency hopping capability stored by network configuring entity 305 (e.g., lookup table (LUT) or other data of hopping monitoring information 344), etc.

Hopping monitoring configuration operation according to some aspects provides on-demand hopping patterns. For example, a network node may configure UE 315 according to concepts herein based upon a request from a LMF, SnMF, UE 315, another UE, etc. A network node (e.g., base station) in wireless communication with a UE is generally responsible for controlling the over the air (OTA) resources, and thus a LMF, a SnMF, or a UE of some examples may request that network node to configure UE 315 with desired OTA resources. In an example in which UE 315 requests a hopping pattern (e.g., monostatic UE sensing), or otherwise requests hopping monitoring configuration operation, UE 315 may provide hopping monitoring configuration signaling (e.g., to a network node, a LMF, a SnMF, etc.) using one or more messages 370. In hopping monitoring configuration operation according to an example, message 370 may include hopping monitoring configuration request 374 configured to initiate or otherwise control hopping pattern configuration with respect to UE 315.

During operation of wireless communications system 300 of the illustrated example, network configuring entity 305 may communicate one or messages 380 to UE 315, such as to request UE capability information, to facilitate hopping monitoring configuration, to request RF sensing information, etc. Network configuring entity 305 may, for example, transmit one or more messages 380 via transmitter 326 operating under control of hopping monitoring configuration logic 342 according to some aspects. In an example in which network configuring entity 305 comprises a network node in wireless communication with UE 315, message 380 may be transmitted directly to UE 315 by network configuring entity 305. In an example, in which network configuring entity 305 is not in wireless communication with UE 315 (e.g., network configuring entity 305 comprises a network element disposed in the network core implementing a LMF or a SnMF separate from network nodes in wireless communication with UE 315), message 380 may be transmitted to UE 315 by network configuring entity 305 via a network node (e.g., a network node of network nodes 105) in wireless communication with UE 315. UE 315 may thus obtain hopping monitoring configuration information (e.g., indication of hopping monitoring configuration 382) via receiver 338 operating under control of hopping monitoring RF sensing logic 346. UE 315 of some examples may implementing one or more hopping monitoring configuration (e.g., in accordance with indication of hopping monitoring configuration 382 and/or other hopping monitoring information, as may be stored in hopping monitoring information 348) for monitoring a reference signal (e.g., via receiver 338 under control of hopping monitoring RF sensing logic 346), such as for radio frequency (RF) sensing, positioning, etc.

According to some aspects, reference signals (not shown) transmitted in operation of RF sensing of some examples herein may use OFDM waveforms, which offer robustness to channel fading and multipath propagation and allow multi-user access. For example, RF sensing may use OFDM signals having high bandwidths to provide high resolution. High bandwidth signals, however, use more complex analog-digital-converters ADC of the sensing equipment (e.g., UE RF sensing circuitry) for signal processing, which consume more power and consume more power.

A standard OFDM model may be represented as follows:

$$χ ( t ) = {\sum }_{b = 0}^{ℬ - 1} {\sum }_{n = 0}^{𝒩 - 1} {d}_{n , b} {e}^{j 2 π n Δ f} rect ( \frac{t - b {T}_{s y m}}{{T}_{s y m}} ) ,$$

where

$${T}_{s y m b} = \frac{1}{Δ f} + {T}_{c p} .$$

Ille total bandwidth is [symbol] =( [symbol] −1)Δf. Also, χ(t) is a wideband baseband signal that occupies the RF channel bandwidth for the whole measurement time [symbol] T_{sym}, where a received signal would need to be sampled with the appropriate large sampling rate.

Processing techniques to retrieve high resolution range-velocity profiles at low sampling rates have been referred to in the literature, including, for example, Benedikt Schweizer et. al, “Stepped-Carrier OFDM-Radar Processing Scheme to Retrieve High Resolution Range-Velocity Profile at Low Sampling Rate,” IEEE Transactions on Microwave Theory and Techniques, Vol. 66, Issue 3, March 2018 the disclosure of which is incorporated herein by reference. In accordance with aspects of the foregoing processing techniques, narrowband OFDM signals are transmitted at multiple stepped carrier frequencies to generate a large RF bandwidth. The premise is to split up each symbol into M sub symbols each one has the small bandwidth

$$W \frac{𝒲}{M}$$

with

$$N \frac{𝒩}{M} =$$

subcarriers. To provide the full RF bandwidth required for high range resolution, M subsymbols are upconverted to different carrier frequencies. The combination of M subsymbols is one block, and the stepped OFDM signal consists of B consecutive blocks.

The stepped OFDM model provides that the Tx baseband for stepped OFDM is:

$$x ( t ) = {\sum }_{b = 0}^{B - 1} {\sum }_{m = 0}^{M - 1} {\sum }_{n = 0}^{N - 1} {d}_{nmb} {e}^{j 2 π n Δ ft} rect ( \frac{t - b MT - mT}{T} ) .$$

The individual subsymbols within a block (indexed by m) are upconverted to the carrier frequency, So that the resulting RF waveform is as follows:

$${x}_{RF} ( t ) = {\sum }_{b = 0}^{B - 1} {\sum }_{m = 0}^{M - 1} {\sum }_{n = 0}^{N - 1} {d}_{nmb} {e}^{j 2 π} ( {f}_{m} + n Δ f ) t .$$

Some examples of hopping monitoring configuration operation may use sub-band carrier OFDM signal monitoring to reduce the sampling rate implemented by UE 315. A sub-band of some aspects may correspond to a subset of frequency resources comprising the baseband bandwidth of a reference signal. In accordance with some examples, sub-bands may correspond to OFDM symbols or subsymbols of a reference signal (e.g., SRS, PRS, etc.) using OFDM waveforms.

The use of sub-band carrier OFDM signal techniques according to some aspects may provide for a relatively low baseband bandwidth of a reference signal being sampled in accordance with a sub-band baseband bandwidth hopping configuration. In operation according to some aspects, UE 315 may be provided with a hopping monitoring configuration indicating one or more patterns of frequency and time domain resources for sub-band sensing operations with respect to a reference signal. Indication of hopping monitoring configuration 382 of one or more messages 380 may, for example, provide a sub-band baseband bandwidth hopping configuration for use by UE 315 with respect to sensing or otherwise monitoring a reference signal.

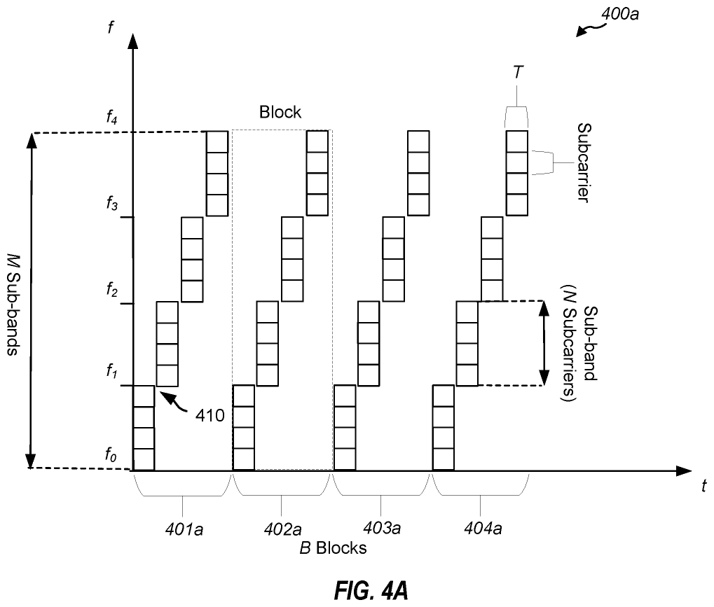

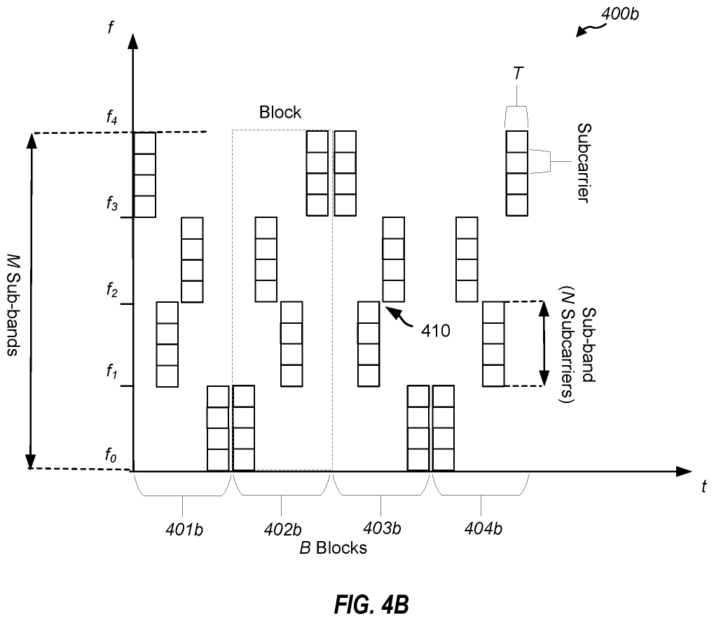

In hopping monitoring configuration operation according to some examples, UE 315 monitors sub-bands of the baseband bandwidth of a reference signal according to one or more patterns of frequency and time domain resources of a hopping monitoring configuration for uniform or regular sub-band sensing operations. FIGS. 4A and 4B show sub-band baseband bandwidth hopping configurations as may be provided by a hopping monitoring configuration according to one or more aspects.

In the example of FIG. 4A, hopping monitoring configuration 400a provides a sub-band frequency hopping pattern for monitoring a reference signal providing M sub-bands (shown as sub-bands f₀-f₁, f₁-f₂, f₂-f₃, and f₃-f₄) within the bandwidth of the reference signal (f₀-f₄) for each of B blocks (shown as blocks 401a-404a) in which the sub-bands are monitored according to the sub-band frequency hopping pattern. Hopping monitoring configuration 400a provides a fully uniform sub-band frequency hopping pattern in which each block includes M sub-bands encompassing N subcarriers within a time period T and the pattern of monitoring each sub-band is repeated in each of the B blocks of the sub-band frequency hopping pattern. That is, hopping monitoring configuration 400a provides a sub-band hopping monitoring pattern that is uniform in both its use of frequency and time resources with respect to each sub-band of the baseband bandwidth and its use of a sub-band pattern from block to block (e.g., same sub-band time series within each block of the B blocks) of the sub-band frequency hopping pattern.

Hopping monitoring configuration 400a of FIG. 4A illustrates an example in which the sub-band frequency hopping pattern provides for adjacent frequencies in time series between the N sub-bands of a block (e.g., a stepped sub-band frequency hopping pattern). Hopping monitoring configurations implemented according to concepts herein may, however, implement other time series relationships between sub-bands and/or between blocks. For example, hopping monitoring configuration 400b of FIG. 4B illustrates an example in which the sub-band frequency hopping pattern provides for non-adjacent frequencies in time series between the N sub-bands of a block (e.g., distributed sub-band frequency hopping pattern).

In the example of FIG. 4B, hopping monitoring configuration 400b provides another sub-band frequency hopping pattern for monitoring a reference signal providing M sub-bands (shown as sub-bands f₀-f₁, f₁-f₂, f₂-f₃, and f₃-f₄.) within the bandwidth of the reference signal (f₀-f₄) for each of B blocks (shown as blocks 401b-404b) in which the sub-bands are monitored according to the sub-band frequency hopping pattern. Hopping monitoring configuration 400b provides a hybrid uniform sub-band frequency hopping pattern in which each block includes M sub-bands encompassing N subcarriers within a time period T, while the pattern of monitoring each sub-band differs in blocks of the B blocks of the sub-band frequency hopping pattern. That is, hopping monitoring configuration 400b provides a sub-band hopping monitoring pattern that is uniform in its use of frequency and time resources with respect to each sub-band of the baseband bandwidth, and its use of a sub-band frequency hopping pattern differs from block to block (e.g., different sub-band time series within blocks of the B blocks) of the sub-band frequency hopping pattern.

Although the examples of hopping monitoring configuration 400a and hopping monitoring configuration 400b are illustrated as having a same number of subcarriers per sub-band, a same number of sub-bands per block, and a same number of blocks per sub-band frequency hopping pattern, it is to be understood that the particular numbers of each of the foregoing are illustrative and may be different from hopping monitoring configuration to hopping monitoring configuration. That is, any or all of the number of subcarriers per sub-band, the number of sub-bands per block, and the number of blocks per sub-band frequency hopping pattern may be changed for a particular implementation of a sub-band frequency hopping configuration of some aspects. Additionally or alternatively, time series relationships between sub-bands and/or between blocks other than those illustrated in the examples of hopping monitoring configuration 400a and hopping monitoring configuration 400b may be utilized for a particular implementation of a sub-band frequency hopping configuration of some aspects.

One or more of the above aspects of a uniform sub-band frequency hopping pattern for a hopping monitoring configuration may be selected (e.g., by operation of hopping monitoring configuration logic 342 using information, such as UE capability information, reference signal information, channel information, an antenna resource hopping configuration to be used, etc., from hopping monitoring information 344) according to the capabilities of the UE, the frequency band of the reference signal, aspects of the communication environment, etc. According to some examples, network configuration entity 305 may determine a uniform (e.g., fully uniform or hybrid uniform) sub-band frequency hopping pattern for transmission of a reference signal (e.g., SRS, PRS, etc.) configured for low baseband bandwidth monitoring by UE 315. The sub-band frequency hopping pattern for transmission of the reference signal may, for example, be determined (e.g., under control of hopping monitoring configuration logic 342 using information of hopping monitoring information 344) based on one or more aspects of the UE capability information, reference signal information, channel information, etc. One or more hopping monitoring configurations (e.g., hopping monitoring configuration 400a, hopping monitoring configuration 400b, etc.) for implementation by UE 315 may be determined to correspond to the sub-band frequency hopping pattern determined with respect to transmission of the reference signal. In some examples, network configuration entity 305 may determine a uniform (e.g., fully uniform or hybrid uniform) sub-band frequency hopping pattern for low baseband bandwidth monitoring of a reference signal (e.g., SRS, PRS, etc.) by UE 315, while a reference signal transmission scheme remains unaltered for the hopping monitoring configuration (e.g., a legacy SRS or PRS being used as a reference signal for hopping monitoring configured RF sensing operation). One or more hopping monitoring configurations (e.g., hopping monitoring configuration 400a, hopping monitoring configuration 400b, etc.) for implementation by UE 315 may be determined to correspond to the sub-band frequency hopping pattern determined with respect to monitoring of the reference signal.

Referring again to FIG. 3, indication of hopping monitoring configuration 382 of one or more messages 380 providing a sub-band baseband bandwidth hopping configuration for use by UE 315 may be configured for facilitating uniform (e.g., fully uniform and hybrid uniform) sub-band frequency hopping patterns. Indication of hopping monitoring configuration 382 may, for example, include data and/or other information indicating various aspects of one or more sub-band frequency hopping patterns, such as those of the examples above. In accordance with some examples, indication of hopping monitoring configuration 382 may include information regarding the number of blocks in the sub-band frequency hopping pattern (e.g., B), the number of sub-bands per block (e.g., M), the inter-sub-band time (e.g., inter-sub-band time 410), the number of subcarriers per symbol, subsymbol, or sub-band (e.g., N), the carrier frequency per symbol, subsymbol, or sub-band per block (e.g., f₀-f₁, f₁-f₂, f₂-f₃, and f₃-f₄), or any combination thereof. Indication of hopping monitoring configuration 382 may additionally or alternatively include information such as one or more of the time sequence of sub-bands per block (e.g., Block1 1:f₃-f₄, 2:f₁-f₂, 3:f₂-f₃, and 4:f₀-f₁, Block2 1:f₀-f₁, 2:f₂-f₃, 3:f₁-f₂, and 4:f₃-f₄, etc.), the sub-band time period (e.g., T), etc. Indication of hopping monitoring configuration 382 may, according to some examples, include data specifying one or more of the foregoing aspects. Additionally or alternatively, indication of hopping monitoring configuration 382 may include an index or other indicator of data regarding hopping monitoring configuration aspects stored by network configuring entity 305 (e.g., LUT or other data of hopping monitoring information 344) and/or UE 315 (e.g., LUT or other data of hopping monitoring information 348).

Uniform (e.g., fully uniform and hybrid uniform) sub-band frequency hopping patterns provided according to hopping monitoring configurations of some examples facilitate high range resolution, similar to that associated with monitoring a relatively large baseband bandwidth, while utilizing less complex sensing circuitry configurations for the relatively low baseband bandwidth monitoring operations. Implementations of uniform sub-band frequency hopping patterns according to some aspects, however, result in a reduction in the maximum detectable velocity corresponding to the number of sub-bands (M) implemented in the sub-band frequency hopping patterns (e.g., maximum detectible velocity is reduced by a factor of M), and a slight reduction (e.g., less than one percent) in velocity resolution. Example embodiments are provided below for operating at a carrier frequency f_{c} of 77 GHz with a Δf of 500 kHz, and period T=2.4 us with M as the number of sub-symbols and B as the number of blocks. For a standard OFDM, M=1 and an example of B=2048 provides a velocity resolution of 0.3963 meters/second. For a uniform stepped-carrier OFDM, M=8 and an example B=2048/M=256 provides a velocity resolution of 0.3977 meters/second, which is a 0.35% increase over the standard OFDM example. Smaller velocity resolutions may provide better results for the UE.

Processing techniques to retrieve high resolution range-velocity and Doppler resolution profiles at low sampling rates have been referred to in the literature, including, for example, Christina Knill et. al, “High Range and Doppler Resolution by application of Compressed Sensing,” IEEE Transactions on Microwave Theory and techniques, Vol. 66, Issue 7, July 2018, the disclosure of which is incorporated herein by reference. In accordance with aspects of the foregoing processing techniques, short sequences of narrowband OFDM pulses of different bandwidths and a randomly chosen discrete frequency pattern are transmitted, rather than a uniform or equal sized OFDM pulses/strict periodic frequency pattern, so that the unambiguity of full transmission is available, through non-deterministic compressed sensing (CS) processing.

The Sparse OFDM model combines a smaller available bandwidth and frequency agility to obtain a larger measurement bandwidth. In one measurement frame, B individual OFDM signals, each consisting of M_b OFDM symbols and N_b subcarriers are transmitted. The OFDM signal in each block are mixed to their common block carrier f_b. In an example, the baseband signal of one block is described by:

$${x}_{b} ( t ) = {\sum }_{m = 0}^{{M}_{b} - 1} {\sum }_{n = 0}^{{N}_{b} - 1} {d}_{b} ( m , n ) {e}^{j 2 π n Δ f t} rect ( \frac{t - mT}{T} )$$

wherein the sparse OFDM signal covers the same total duration and measurement bandwidth as a comparative full OFDM.

Some examples of hopping monitoring configuration operation may use sub-band carrier OFDM signal monitoring to reduce the sampling rate implemented by UE 315 while achieving full standard OFDM performance (e.g., without sacrificing maximum detectible velocity). The use of such sub-band carrier OFDM signal techniques according to some aspects may nevertheless provide for a relatively low baseband bandwidth of a reference signal being sampled in accordance with a sub-band baseband bandwidth hopping configuration.

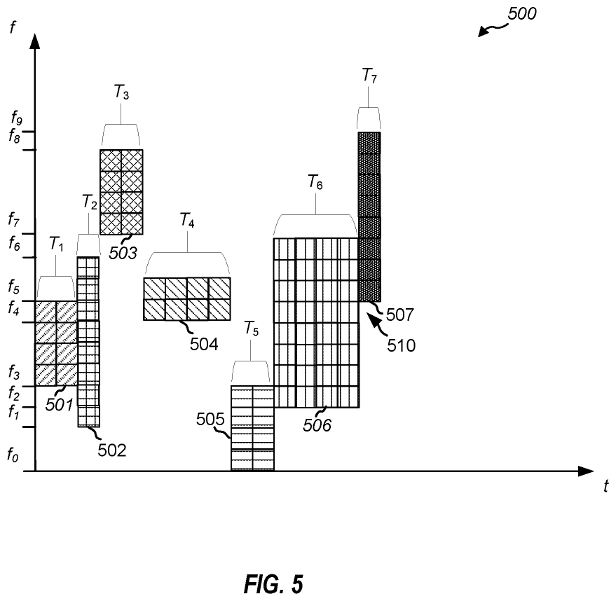

In hopping monitoring configuration operation according to some examples, UE 315 monitors sub-bands of the baseband bandwidth of a reference signal according to one or more patterns of frequency and time domain resources of a hopping monitoring configuration for non-uniform or irregular sub-band sensing operations. FIG. 5 shows a sub-band baseband bandwidth hopping configuration as may be provided by a hopping monitoring configuration according to one or more aspects.

In the example of FIG. 5, hopping monitoring configuration 500 provides a sub-band frequency hopping pattern for monitoring a reference signal providing B blocks (shown as blocks 501-507) corresponding to respective sub-bands (shown as sub-bands f₃-f₅, f₁-f₆, f₇-f₈, f₄-f₅, f₀-f₃, f₂-f₇, and f₅-f₉) within the bandwidth of the reference signal (f₀-f₉) in which the sub-bands are monitored according to the sub-band frequency hopping pattern. Hopping monitoring configuration 500 provides a non-uniform sub-band frequency hopping pattern in which the sub-bands of blocks encompasses different numbers of subcarriers and/or time periods (e.g., block 501 N₁=8, T₁=2, block 502 N₂=8, T₂=1, block 503 N₃=8, 73=2, block 504 N₄=8, T₁=4, block 505 N₅=8, T₅=2, block 506 N₆=32, T₁=4, and block 507 N₇=8, T₁=1). That is, hopping monitoring configuration 500 provides a sub-band hopping monitoring pattern that is non-uniform in both its use of frequency and time resources with respect to sub-bands of the baseband bandwidth and its use of a sub-band pattern from block to block of the sub-band frequency hopping pattern.

Hopping monitoring configuration 500 of FIG. 5 illustrates an example in which the sub-band frequency hopping pattern provides for some blocks having a same number of subcarriers and time period and other blocks having different number of subcarriers and/or time period. Hopping monitoring configurations implemented according to concepts herein may, however, implement other subcarrier and time period configurations between sub-bands and/or between blocks. For example, each block of a hopping monitoring configuration may provide for a different combination of number of subcarriers and time periods. One or more of the above aspects of a hopping monitoring configuration may be selected (e.g., by operation of hopping monitoring configuration logic 342 using information, such as UE capability information, reference signal information, channel information, an antenna resource hopping configuration to be used, etc., from hopping monitoring information 344) according to the capabilities of the UE, the frequency band of the reference signal, aspects of the communication environment, etc.

One or more of the above aspects of a non-uniform sub-band frequency hopping pattern for a hopping monitoring configuration may be selected (e.g., by operation of hopping monitoring configuration logic 342 using information, such as UE capability information, reference signal information, channel information, an antenna resource hopping configuration to be sued, etc., from hopping monitoring information 344) according to the capabilities of the UE, the frequency band of the reference signal, aspects of the communication environment, etc. According to some examples, network configuration entity 305 may determine a non-uniform sub-band frequency hopping pattern for transmission of a reference signal (e.g., SRS, PRS, etc.) configured for low baseband bandwidth monitoring by UE 315. The sub-band frequency hopping pattern for transmission of the reference signal may, for example, be determined (e.g., under control of hopping monitoring configuration logic 342 using information of hopping monitoring information 344) based on one or more aspects of the UE capability information, reference signal information, channel information, etc. One or more hopping monitoring configurations (e.g., hopping monitoring configuration 500, etc.) for implementation by UE 315 may be determined to correspond to the sub-band frequency hopping pattern determined with respect to transmission of the reference signal. In some examples, network configuration entity 305 may determine a non-uniform sub-band frequency hopping pattern for low baseband bandwidth monitoring of a reference signal (e.g., SRS, PRS, etc.) by UE 315, while a reference signal transmission scheme remains unaltered for the hopping monitoring configuration (e.g., a legacy SRS or PRS being used as a reference signal for hopping monitoring configured RF sensing operation). One or more hopping monitoring configurations (e.g., hopping monitoring configuration 500, etc.) for implementation by UE 315 may be determined to correspond to the sub-band frequency hopping pattern determined with respect to monitoring of the reference signal.

In accordance with some examples, one or more sets or lists of non-uniform sub-band frequency hopping patterns may be specified (e.g., predetermined, adopted in the 3GPP standards, etc.). Non-uniform sub-band frequency hopping patterns of a specified set may, for example, be the result of studies, empirical observation, etc. According to some examples, network configuration entity 305 may select a non-uniform sub-band frequency hopping pattern for transmission of a reference signal (e.g., SRS, PRS, etc.) configured for low baseband bandwidth monitoring by UE 315. The sub-band frequency hopping pattern for transmission of the reference signal may, for example, be selected (e.g., under control of hopping monitoring configuration logic 342) from the one or more sets of non-uniform sub-band frequency hopping patterns (e.g., stored in hopping monitoring information 344) based on one or more aspects of the UE capability information, reference signal information, channel information, etc. One or more hopping monitoring configurations (e.g., hopping monitoring configuration 500, etc.) for implementation by UE 315 may be determined to correspond to the sub-band frequency hopping pattern selected with respect to transmission of the reference signal. In some examples, network configuration entity 305 may select a non-uniform sub-band frequency hopping pattern for low baseband bandwidth monitoring of a reference signal (e.g., SRS, PRS, etc.) by UE 315, while a reference signal transmission scheme remains unaltered for the hopping monitoring configuration (e.g., a legacy SRS or PRS being used as a reference signal for hopping monitoring configured RF sensing operation). One or more hopping monitoring configurations (e.g., hopping monitoring configuration 500, etc.) for implementation by UE 315 may be determined to correspond to the sub-band frequency hopping pattern selected with respect to monitoring of the reference signal.

Referring yet again to FIG. 3, indication of hopping monitoring configuration 382 of one or more messages 380 providing a sub-band baseband bandwidth hopping configuration for use by UE 315 may be configured for facilitating non-uniform sub-band frequency hopping patterns. Indication of hopping monitoring configuration 382 may, for example include data and/or other information indicating various aspects of one or more sub-band frequency hopping patterns, such as those of the examples above. In accordance with some examples, indication of hopping monitoring configuration 382 may include information regarding the number of blocks in the sub-band frequency hopping pattern (e.g., B), the carrier frequency per sub-band per block (e.g., f₃-f₅, f₁-f₆, f₇-f₈, f₄-f₅, f₀-f₃, f₂-f₇, and f₅-f₉), the number of subcarriers per symbol, subsymbol, or sub-band (e.g., N_{X}), the subcarriers occupied by each symbol, subsymbol, or sub-band per block (e.g., specified by a bitmap or a resource block group (RBG) bitmap similar Downlink Resource Allocation Type 0, by encoded value of the starting resource block number and the length of resource blocks (RBs) similar to resource indicator value (RIV) in Downlink Resource Allocation Type 1, etc.), or any combination thereof. Indication of hopping monitoring configuration 382 may additionally or alternatively include information such as one or more of the time sequence of block sub-band configurations (e.g., Block1, Block2 Block3, Block4, etc.), the sub-band time period per block (e.g., Ty), the inter-sub-band time (e.g., inter-sub-band time 510), etc. Indication of hopping monitoring configuration 382 may, for example, include data specifying one or more of the foregoing aspects. Additionally or alternatively, indication of hopping monitoring configuration 382 may include an index or other indicator of data regarding hopping monitoring configuration aspects stored by network configuring entity 305 (e.g., LUT or other data of hopping monitoring information 344). In accordance with some examples, indication of hopping monitoring configuration 382 may include an index to indicate a selected sub-band frequency hopping pattern of one or more previously specified sets of non-uniform sub-band frequency hopping patterns.

Non-uniform sub-band frequency hopping patterns provided according to hopping monitoring configurations of some examples facilitate higher SNR than provided according to some examples of a uniform sub-band frequency hopping pattern. Non-uniform sub-band frequency hopping patterns provided according to hopping monitoring configurations of some examples further facilitate construction of equivalent standard full OFDM scheme with low baseband bandwidth signal monitoring (e.g., 10-20% of the RF bandwidth can be sufficient to achieve the full OFDM performance). However, implementation of non-uniform sub-band frequency hopping patterns of a hopping monitoring configuration of some examples utilizes higher computational complexity (e.g., to construct a range-Doppler map) than may be utilized with respect to examples of a uniform sub-band frequency hopping pattern.

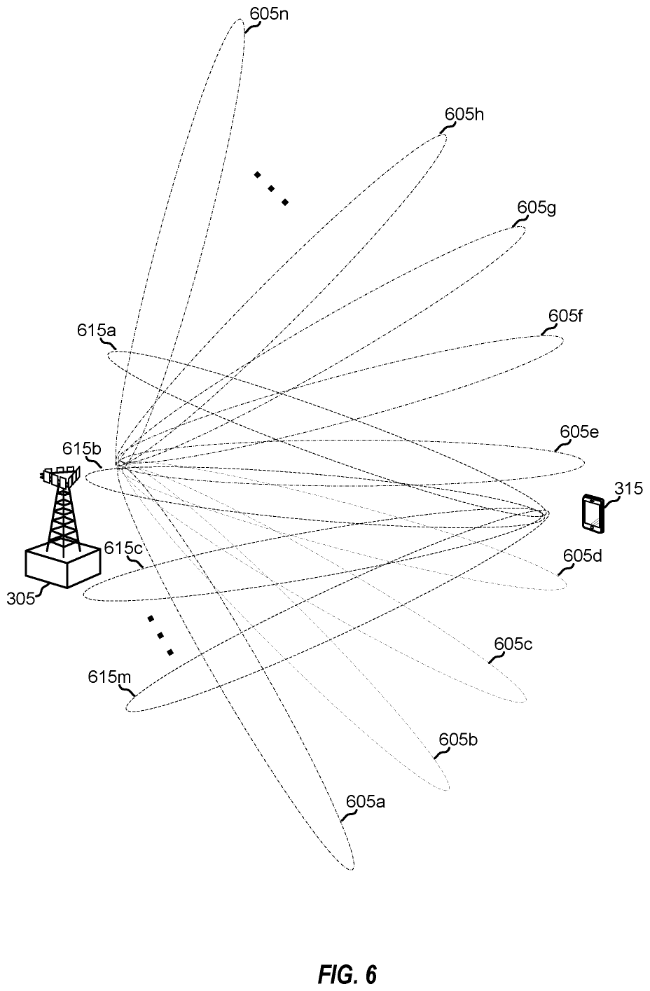

Beamforming may be utilized by one or more devices of wireless communications system 300, such as for avoiding interference, for providing improved signal conditions at a receiving device, etc. FIG. 6 shows use of a plurality of antenna beams according to one or more aspects. In the example of FIG. 6, network configuring entity 305 may use multiple antennas or antenna arrays to conduct beamforming operations to provide multiple antenna beams for directional communications with a UE 315. For instance, some signals (e.g. synchronization signals, reference signals, hopping monitoring configuration signals, and/or other signals) may be transmitted by network configuring entity 305 and some signals (e.g., UE capability signals, hopping monitoring request signals, RF sensing information signals, and/or other signals) may be received by network configuring entity 305 using one or more antenna beams of a plurality of antenna beams (shown as antenna beams 605a-605n) having the same or different configurations (e.g., different azimuthal directions/orientations, beam widths/field of view, beam lengths/gain, etc.). Although the example of FIG. 6 shows network configuring entity 305 transmitting and receiving signals to/from UE 315, it should be understood that some examples may implement a network configuring entity separate or disaggregated from network nodes in wireless communication with UE 315, and thus network configuring entity 315 as illustrated in FIG. 6 may represent the combination of the network configuring entity and network node in communication with UE 315.

Further in the example of FIG. 6, UE 315 may use multiple antennas or antenna arrays, such as to conduct beamforming operations to provide multiple antenna beams for directional communication network configuring entity 305. For instance, some signals (e.g. UE capability signals, hopping monitoring request signals, RF sensing information signals, and/or other signals) may be transmitted and some signals (e.g., synchronization signals, reference signals, hopping monitoring configuration signals, and/or other signals) may be received by a UE 315 using one or more antenna beams of a plurality of antenna beams (shown as antenna beams 615a-615m) having the same or different configurations (e.g., different azimuthal directions, beam widths, beam lengths, beam orientations, etc.).

Although the set of antenna beams 605a-605n and the set of antenna beams 615a-615m are each shown as having antenna beams of same or similar beam widths/field of view and beam lengths/gain providing different azimuthal directions/orientations, it is to be understood that different configurations of antenna beams may be utilized according to some aspects. For example, the set of antenna beams 605a-605n and/or the set of antenna beams 615a-615m may include beams of different beam widths/field of view and/or beams of different beam lengths/gain. Additionally or alternatively, the set of antenna beams 605a-605n and/or the set of antenna beams 615a-615m may include beams providing a same or similar azimuthal directions/orientations, such as a relatively narrow antenna beam and a relatively wide antenna beam oriented in a same or similar azimuthal direction.

In addition to or in the alternative to hopping monitoring configuration operation implementing one or more sub-band frequency patterns, hopping monitoring configuration according to some examples may provide for antenna resource hopping with respect to UE 315 monitoring a reference signal. According to some examples, UE 315 monitors symbols, subsymbols, or sub-bands of the baseband bandwidth of a reference signal according to one or more antenna resources of an antenna resource hopping configuration. In operation according to some aspects, UE 315 may be provided with a hopping monitoring configuration indicating one or more antenna resource hopping configurations for use with respect to a reference signal. Indication of hopping monitoring configuration 382 of one or more messages 380 may, for example, provide an antenna resource hopping configuration for use by UE 315 with respect to sensing or otherwise monitoring a reference signal.

An antenna resource hopping configuration of some aspects may include a subset of antennas (e.g., antenna arrays, antenna elements, antenna ports, etc.), which may be different than antenna resources used in monitoring one or more other signals (e.g., control signals, data signals, etc.), that UE 315 uses for monitoring each OFDM symbol of a reference signal. For example, a subset of antennas designated by an antenna resource hopping configuration may correspond to an antenna beam (e.g., an extension of angular maps) of antenna beams 615a-615m to be used by UE 315 in monitoring the reference signal, such as to provide antenna gain, improved SNR, etc. (e.g., at the expense of reduced field of view or angular resolution, proportional to the number of receive antennas) with respect to monitoring of a reference signal. The subset of antennas of an antenna hopping configuration can follow a uniform partition or non-uniform partition according to some aspects. An example uniform partition for a linear array of 100 antennas may have partitions of size ten, in which antennas 0-9 are used for first sub-symbols, antennas 10-19 are used for second sub-symbols, antennas 20-29 are used for third sub-symbols, and continuing the pattern of antennas indexed N to (N+size−1) assigned to the Nth sub-symbol. Another example uniform partition for a linear array of 100 antennas may have partitions of size 25 with antennas 0-24 assigned to group one, antennas 25-49 assigned to group two, antennas 50-74 assigned to group three, and antennas 75-99 assigned to group four, with the different groups of antennas assigned to certain subsymbols. In contrast, a non-uniform partitioning is a partitioning that does not conform to a uniform partitioning. An example non-uniform partition of 100 antennas into four groups, may assign 0, 1, 2, 4 as a first group, antennas 5, 6, 7, 23, 54, 77 as a second group, antennas 50 through 59 as a third group, and antennas 5 through 99 as a fourth group. Both uniform and non-uniform partitioning are example embodiments for the signaling described in this disclosure. A uniform partitioning of the antennas provides lower-complexity processing although lower flexibility in assignments, while non-uniform portioning of the antennas provides more flexibility in assignments although at a higher processing complexity.

According to some examples, an antenna resource hopping configuration may include subsets of antennas (e.g., antenna arrays, antenna elements, antenna ports, etc.) providing a pattern of antenna resources for use by one or more wireless communication devices (e.g., UE) on a per orthogonal frequency division multiplexing (OFDM) symbol or sub-band basis in RF sensing operation. For example, a subset of antennas designated by an antenna hopping configuration may correspond to a subset of antenna beams of antenna beams 615a-615m, such as may provide angular diversity with respect to reception of a reference signal. An antenna hopping configuration of some examples provides an antenna hopping pattern for monitoring a reference signal providing A antennas (e.g., antenna arrays, antenna elements, antenna ports, etc.) corresponding to respective antenna beams (a set of antenna beams 615a-615m) in which symbols, subsymbols, or sub-bands of a reference signal are monitored according to the antenna hopping pattern (e.g., Antenna1 corresponding to antenna beam 615a, Antenna2 corresponding to antenna beam 615b, Antenna3 corresponding to antenna beam 615c, etc.). In operation according to some examples, network configuring entity 605 may implement an antenna hopping pattern (e.g., a same antenna hopping pattern as implemented at UE 315 or a different antenna hopping pattern than implemented at UE 315) when transmitting a reference signal for monitoring by UE 315 according to an antenna hopping pattern of aspects.

An antenna resource hopping configuration may provide for uniform or regular antenna resource hopping in which each antenna beam of the antenna resource hopping configuration has the same or similar attributes (e.g., beam widths/field of view and beam lengths/gain), although oriented in a different azimuthal direction), and is monitored in a sequential antenna beam sweep (e.g., Antenna1 corresponding to antenna beam 615a, Antenna2 corresponding to antenna beam 615b, Antenna3 corresponding to antenna beam 615c, etc.). In another example, an antenna resource hopping configuration provides for non-uniform or irregular antenna resource hopping in which antenna beams of the antenna resource hopping configuration have different attributes (e.g., beam widths/field of view and/or beam lengths/gain) and/or are monitored in an antenna beam jumping order (e.g., Antenna2 corresponding to antenna beam 615b, Antenna1 corresponding to antenna beam 615a, Antenna3 corresponding to antenna beam 615c, etc.).

One or more of the above aspects of an antenna resource hopping configuration may be selected (e.g., by operation of hopping monitoring configuration logic 342 using information, such as UE capability information, reference signal information, channel information, etc., from hopping monitoring information 344) according to the capabilities of the UE, the frequency band of the reference signal, aspects of the communication environment, a sub-band frequency hopping configuration to be used, etc. According to some examples, network configuration entity 305 may determine an antenna resource hopping configuration for transmission of a reference signal (e.g., SRS, PRS, etc.) configured for monitoring by UE 315. The antenna resource hopping configuration for transmission of the reference signal may, for example, be determined (e.g., under control of hopping monitoring configuration logic 342 using information of hopping monitoring information 344) based on one or more aspects of the UE capability information, reference signal information, channel information, the sub-band frequency hopping pattern to be used, etc. One or more antenna resource hopping configurations for implementation by UE 315 may be determined to correspond to the sub-band frequency hopping pattern determined with respect to transmission of the reference signal.

Referring once again to FIG. 3, indication of hopping monitoring configuration 382 of one or more messages 380 providing an antenna resource hopping configuration for use by UE 315 may be configured for facilitating antenna resource hopping. Indication of hopping monitoring configuration 382 may, for example include data and/or other information indicating various aspects of one or more antenna resource hopping configuration, such as those of the examples above. In accordance with some examples, indication of hopping monitoring configuration 382 may include information regarding one or more antenna (e.g., antenna arrays, antenna elements, antenna ports, etc.) for use in monitoring a reference signal. Indication of hopping monitoring configuration 382 may additionally or alternatively include information such the time sequence of antenna resources (e.g., Antenna1 corresponding to antenna beam 615a, Antenna2 corresponding to antenna beam 615b, Antenna3 corresponding to antenna beam 615c, etc.). Indication of hopping monitoring configuration 382 may, for example, include data specifying one or more of the foregoing aspects. Additionally or alternatively, indication of hopping monitoring configuration 382 may include an index or other indicator of data regarding hopping monitoring configuration aspects stored by network configuring entity 305 (e.g., LUT or other data of hopping monitoring information 344).

The use of antenna resource hopping of some examples may provide for power savings realized by UE 315. For example, an antenna resource hopping configuration may use a relatively small. number of antennas as compared to generally used with respect to reference signal monitoring. Such antenna resource hopping configurations may, however, experience a reduced field of view or angular resolution proportional to the total number of receive antennas used.

In operation according to some aspects, UE 315 may implement one or more hopping monitoring configurations (e.g., sub-band baseband bandwidth hopping configuration and/or antenna hopping configuration), such as may be provided by one or more messages 380 and/or stored in hopping monitoring information 348. For example, UE 315 may configure processing for the reference signal (e.g., configure one or more aspects of receiver 338 under control of hopping monitoring RF sensing logic 346) according to the indication of the hopping monitoring configuration in order to perform reference signal (e.g., SRS, PRS, etc.) monitoring (e.g., via receiver 338 operating under control of hopping monitoring RF sensing logic 346) in accordance with a hopping monitoring configuration. For example, sub-bands of a reference signal bandwidth may be sampled by UE 315 in RF sensing operation. Additionally or alternatively, a reference signal may be sampled by UE 315 using subsets of antennas in RF sensing operation.

According to some examples, UE 315 may provide reporting of information regarding the reference signal monitoring performed using a hopping monitoring configuration. For example, UE 315 may transmit one or more messages 390 via transmitter 336 operating under control of hopping monitoring RF sensing logic 346 to network configuring entity 305 and/or one or more network nodes. Information provided via messages 390 may, for example, comprise raw data as sampled with respect to the reference signal, processed data (e.g., position data, velocity data, etc.) derived (e.g., by operation of hopping monitoring RF sensing logic 346) from data as sampled with respect to the reference signal, etc. In the illustrated example, message 390 includes RF sensing information 392 transmitted by UE 315. One or more network node (e.g., network configuring entity 305, a base station in wireless communication with UE 315, UE 315 itself, such as when operating in a monostatic UE sensing mode, etc.) may utilize the information regarding the reference signal monitoring in various functions, such as resource allocation, scheduling, management of communications, etc.

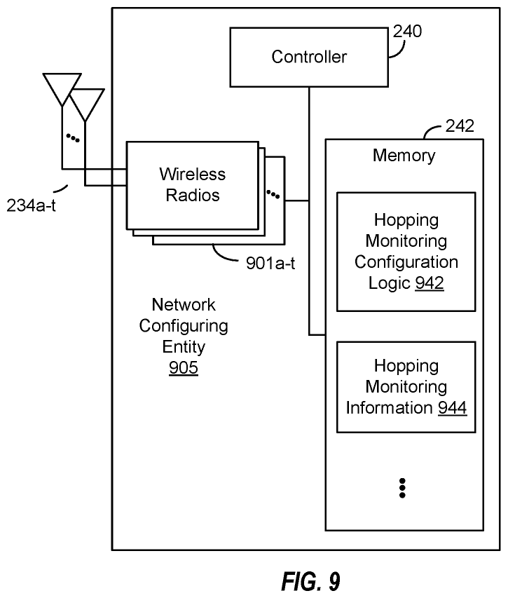

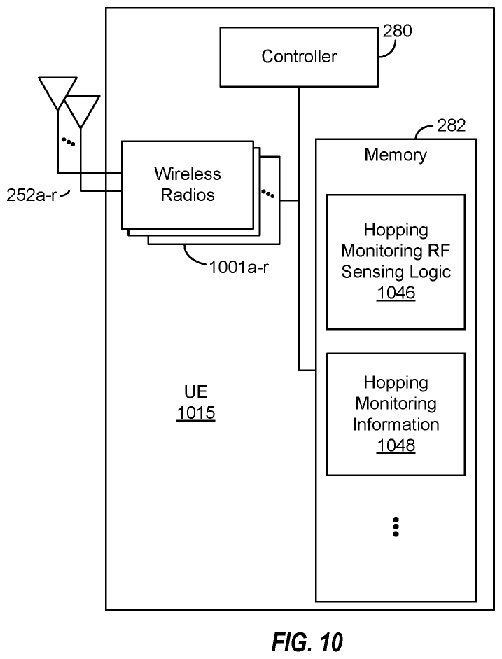

FIGS. 7 and 8 are flow diagrams illustrating example processes that support hopping monitoring configuration according to one or more aspects. The process of the example of FIG. 7 may, for example, be performed by or under control of a network configuring entity according to some aspects. FIG. 9 is a block diagram of an example network configuring entity that supports hopping monitoring configuration according to one or more aspects. The process of the example of FIG. 8 may be performed by or under control of a UE according to some aspects. FIG. 10 is a block diagram of an example UE that supports hopping monitoring configuration according to one or more aspects.

FIG. 7 is a flow diagram illustrating an example process 700 that supports hopping monitoring configuration according to one or more aspects. Operations of process 700 may be performed by a network configuring entity, such as may comprise network node 105 described above with reference to FIGS. 1 and 2, a network configuring entity as described with reference to FIGS. 3 and 9, etc. For example, operations (also referred to as “blocks”) of process 700 may enable instances of network node 105, network configuring entity 305, and network configuring entity 905 to support hopping monitoring configuration operation.

FIG. 9 is a block diagram of an example network configuring entity 905 that supports hopping monitoring configuration according to one or more aspects. The example of FIG. 9 illustrates network configuring entity integrated with functionality of a network node (e.g., network node 105 of FIGS. 1 and 2), such as may comprise a network node implementing SnMF, possibly as part of a LMF. It is to be understood that network configuring entity 905 of some examples may comprise a network configuring functionality (e.g., SnMF and/or a LMF) separate or disaggregated from a network node in wireless communication with UEs.

Network configuring entity 905 may be configured to perform operations, including the blocks of process 700 described with reference to FIG. 7. In some implementations, network configuring entity 905 includes the structure, hardware, and components shown and described with reference to network node 105 of FIGS. 1 and 2 and/or network configuring entity 305 of FIG. 3. For example, network configuring entity 905 may include controller 240, which operates a part of a processing system to execute logic or computer instructions stored in memory 242 coupled thereto, as well as controlling the components of network configuring entity 905 that provide the features and functionality of network configuring entity 905. Network configuring entity 905, under control of controller 240, transmits and receives signals via wireless radios 901a-t and antennas 934a-t. Wireless radios 901a-t include various components and hardware, as illustrated in FIG. 2 for network node 105, including modulator and demodulators 232a-t, transmit processor 220, TX MIMO processor 230, MIMO detector 236, and receive processor 238.

As shown, the memory 242 may include hopping monitoring configuration logic 942 and hopping monitoring information 944. Hopping monitoring configuration logic 942 of some examples may correspond to hopping monitoring configuration logic 342 of FIG. 3 and perform functions thereof. Hopping monitoring information 944 of some examples may correspond to hopping monitoring information 344 and comprise information thereof. Hopping monitoring configuration logic 942 may be configured to perform, manage, and/or control various functionality of hopping monitoring configuration operation described herein, such as obtaining UE capability information, hopping monitoring configuration requests, RF sensing information, etc. from one or more UEs, determining hopping monitoring configurations for a reference signal, providing one or more hopping monitoring configurations to UEs, etc. Hopping monitoring information 944 may store various data utilized by hopping monitoring configuration logic 942 in performing, managing, and/or controlling hopping monitoring configuration operation. Network configuring entity 905 may receive signals from or transmit signals to one or more UEs, such as UE 115 of FIGS. 1 and 2, UE 315 of FIG. 3, and UE 1015 of FIG. 10.

Referring again to FIG. 7, at block 701 of process 700, the network configuring entity determines a hopping monitoring configuration for a reference signal. For example, hopping monitoring configuration logic 942 of network configuring entity 905 may analyze one or more aspects of UE capability information, reference signal information, channel information, reference signal frequency band, communication environment, etc. to determine one or more hopping monitoring configuration for implementation by UE 315 with respect to monitoring a reference signal (e.g., a SRS, PRS, etc. transmitted by network configuring entity 905 or another network node of the wireless communication network).

According to some examples, a network configuring entity may obtain UE capability information regarding UE hopping monitoring capability. For example, prior to operation to determine a hopping monitoring configuration at block 701, an example of network configuring entity 905 may receive (e.g., via one or more of wireless radios 901a-t operating under control of hopping monitoring configuration logic 942), from one or more UEs, an indication of capability regarding one or more capability of the UEs for baseband frequency hopping. The indication of capability may for example comprise a minimum time for the UE to implement frequency hopping between two transmissions, a minimum time for the UE to implement frequency hopping between two receptions, or a combination thereof.

In operation according to some examples, a determination of a hopping monitoring configuration at block 701 of process 700 may be initiated in response to or otherwise in association with a hopping monitoring configuration request. For example, process 700 of some examples may provide for on-demand hopping patterns, whereby a network node may configure one or more UEs based upon a request from a LMF, SnMF, the UE itself, another UE, etc. Determining a hopping monitoring configuration by network configuring entity 905 may be performed in response to such a hopping monitoring configuration request. In accordance with some examples, UE configuration information regarding UE capabilities regarding hopping monitoring capability may be utilized both for a hopping monitoring configuration request and providing UE capability information.

The hopping monitoring configuration determined according to block 701 of some examples of process 700 may comprise a sub-band baseband bandwidth hopping configuration, an antenna hopping configuration, or both. The hopping monitoring configuration may, for example, comprise a sub-band baseband bandwidth hopping configuration providing a uniform sub-band frequency hopping pattern. According to some aspects, the indication of the hopping monitoring configuration may comprise an indication of a number of blocks, an inter-sub-band time, a number of subcarriers per sub-band, a carrier frequency per sub-band, or any combination thereof. The hopping monitoring configuration may, according to some examples, comprise a sub-band baseband bandwidth hopping configuration providing a non-uniform sub-band frequency hopping pattern. According to some aspects, the indication of the hopping monitoring configuration may comprise an indication a number of blocks, a hopping value for blocks, a number of sub-bands per block, subcarriers occupied by a sub-band, or any combination thereof. According to further aspects, the indication of the hopping monitoring configuration may comprise a bitmap assigning at least some combinations of subcarriers to the sub-band frequency hopping pattern. The hopping monitoring configuration may additionally or alternatively comprise an antenna hopping configuration providing a subset of antenna resources for use by the UE for each OFDM symbol or sub-band of a baseband bandwidth of the hopping monitoring configuration. According to some aspects, the antenna hopping configuration may provide uniform partitioning of the antenna resources. According to further aspects, the antenna hopping configuration may provide non-uniform partitioning of the antenna resources.

At block 702, the network configuring entity provides, for one or more UEs, an indication of the hopping monitoring configuration. For example, hopping monitoring configuration logic 942 of network configuring entity 905 may provide an indication of a hopping monitoring configuration for transmission to one or more UEs. According to some examples, network configuring entity 905 may transmit (e.g., via one or more of wireless radios 901a-t operating under control of hopping monitoring configuration logic 942) an indication of one or more hopping monitoring configuration to one or more UEs.

In operation according to some examples, a providing an indication of hopping monitoring configuration at block 702 of process 700 may be initiated in response to or otherwise in association with a hopping monitoring configuration request. For example, as described above, process 700 of some examples may provide for on-demand hopping patterns responsive to a hopping monitoring configuration request. Providing a hopping monitoring configuration by network configuring entity 905 may be performed in response to such a hopping monitoring configuration request.

The indication of hopping monitoring configuration provided according to block 702 of some examples of process 700 may comprise data specifying one or more aspects of the hopping monitoring configuration. The indication of the hopping monitoring configuration may, additionally or alternatively, comprise an index value, wherein the index value identifies at least one of a plurality of predefined sub-band baseband bandwidth hopping patterns. For example, the indication of hopping monitoring configuration may include an index or other indicator of data regarding hopping monitoring configuration aspects stored by network configuring entity 905 and/or a UE to which the indication of hopping monitoring configuration is provided.

In operation according to some examples, one or more UE may implement the hopping monitoring configuration with respect to monitoring a reference signal (e.g., a SRS, PRS, etc., as may be transmitted by network configuring entity 905 or another network entity). Accordingly, although not expressly set forth in the example of flow 700 in FIG. 7, the network configuring entity may obtain information regarding a reference signal monitored by one or more UEs in accordance with the indication of hopping monitoring configuration. For example, network configuring entity 905 may receive (e.g., via one or more of wireless radios 901a-t operating under control of hopping monitoring configuration logic 942), from one or more UEs, RF sensing information and/or other information with respect to monitoring a reference signal.

FIG. 8 is a flow diagram illustrating an example process 800 that supports hopping monitoring configurations according to one or more aspects. Operations of process 800 may be performed by a UE, such as UE 115 described above with reference to FIGS. 1 and 2, a UE described with reference to FIGS. 3 and 10, etc. For example, operations of process 800 may enable UE 1015 to support hopping monitoring configuration operation.

FIG. 10 is a block diagram of an example UE 1015 that supports hopping monitoring configuration according to one or more aspects. UE 1015 may be configured to perform operations, including the blocks of process 800 described with reference to FIG. 8. In some implementations, UE 1015 includes the structure, hardware, and components shown and described with reference to UE 115 of FIGS. 1 and 2 and/or UE 315 of FIG. 3. For example, UE 1015 includes controller 280, which operates as part of a processing system to execute logic or computer instructions stored in memory 282 coupled thereto, as well as controlling the components of UE 1015 that provide the features and functionality of UE 1015. UE 1015, under control of controller 280, transmits and receives signals via wireless radios 1001a-r and antennas 252a-r. Wireless radios 1001a-r include various components and hardware, as illustrated in FIG. 2 for UE 115, including modulator and demodulators 254a-r, MIMO detector 256, receive processor 258, transmit processor 264, and TX MIMO processor 266.

As shown, memory 282 may include hopping monitoring RF sensing logic 1046 and hopping monitoring information 1048. Hopping monitoring RF sensing logic 1046 may be configured to perform, manage, and/or control various functionality of hopping monitoring configuration operation described herein, such as providing UE capability information, hopping monitoring configuration requests, RF sensing information, etc. to one or more network configuring entities and/or other network entities in communication with UE 1015, obtain one or more hopping monitoring configurations from network monitoring entities, configure processing for a reference signal according to a hopping monitoring configuration, etc. Hopping monitoring information 1048 may store various data utilized by hopping monitoring RF sensing logic 1046 in performing, managing, and/or controlling hopping monitoring configuration operation. UE 1015 may receive signals from or transmit signals to one or more network entities, such as network node 105 of FIGS. 1 and 2, network configuring entity 305 of FIG. 3, and network configuring entity 905 of FIG. 9.

Referring again to FIG. 8, at block 801 of process 800, the UE obtains, by the UE from a network configuring entity, an indication of a hopping monitoring configuration for a reference signal. For example, hopping monitoring RF sensing logic 1046 may receive (e.g., via one or more wireless radios 1001a-r operating under control of hopping monitoring RF sensing logic 1046) an indication of one or more hopping monitoring configuration from a network configuring entity or a network node in wireless communication with UE 1015.

According to some examples, UE 1015 may provide UE capability information regarding hopping monitoring capability. For example, prior to operation to obtain a hopping monitoring configuration at block 801, an example of UE 1015 may transmit (e.g., via one or more of wireless radios 1001a-r operating under control of hopping monitoring RF sensing logic 1046), to one or more network configuring entities, an indication of capability regarding one or more capability of the UEs for baseband frequency hopping. The indication of capability may for example comprise a minimum time for the UE to implement frequency hopping between two transmissions, a minimum time for the UE to implement frequency hopping between two receptions, or a combination thereof.

In operation according to some examples, obtaining a hopping monitoring configuration at block 801 of process 800 may be in response to or otherwise in association with a hopping monitoring configuration request. For example, process 800 of some examples may provide for on-demand hopping patterns, whereby a network node may configure UE 1015 based upon a request from a LMF. SnMF, UE 1015 itself, another UE, etc. Obtaining a hopping monitoring configuration by UE 1015 may be in association with such a hopping monitoring configuration request. In accordance with some examples, UE configuration information regarding UE capabilities regarding hopping monitoring capability may be provided both a hopping monitoring configuration request and UE capability information.

The hopping monitoring configuration obtained according to block 801 of some examples of process 800 may comprise a sub-band baseband bandwidth hopping configuration, an antenna hopping configuration, or both. The hopping monitoring configuration may, for example, comprise a sub-band baseband bandwidth hopping configuration providing a uniform sub-band frequency hopping pattern. According to some aspects, the indication of the hopping monitoring configuration may comprise an indication of a number of blocks, an inter-sub-band time, a number of subcarriers per sub-band, a carrier frequency per sub-band, or any combination thereof. The hopping monitoring configuration may, according to some examples, comprise a sub-band baseband bandwidth hopping configuration providing a non-uniform sub-band frequency hopping pattern. According to some aspects, the indication of the hopping monitoring configuration may comprise an indication a number of blocks, a hopping value for blocks, a number of sub-bands per block, subcarriers occupied by a sub-band, or any combination thereof. According to further aspects, the indication of the hopping monitoring configuration may comprise a bitmap assigning at least some combinations of subcarriers to the sub-band frequency hopping pattern. The hopping monitoring configuration may additionally or alternatively comprise an antenna hopping configuration providing a subset of antenna resources for use by the UE for each OFDM symbol or sub-band of a baseband bandwidth of the hopping monitoring configuration. According to some aspects, the antenna hopping configuration may provide uniform partitioning of the antenna resources. According to further aspects, the antenna hopping configuration may provide non-uniform partitioning of the antenna resources.

At block 802, the UE configures processing for the reference signal according to the indication of the hopping monitoring configuration. For example, hopping monitoring RF sensing logic 1046 of UE 1015 may configure one or more aspects of wireless radios 1001a-r according to the indication of the hopping monitoring configuration in order to perform reference signal (e.g., SRS, PRS, etc.) monitoring in accordance with a hopping monitoring configuration. According to some examples, hopping monitoring RF sensing logic 1046 may directly use data of the indication of hopping monitoring configuration to configure aspects of wireless radios 1001a-r and/or to perform processing with respect to a monitored reference signal. Additionally or alternatively, hopping monitoring RF sensing logic 1046 may indirectly use data of the indication of hopping monitoring configuration to configure aspects of wireless radios 1001a-r and/or to perform processing with respect to a monitored reference signal. For example, where indication of hopping monitoring configuration includes an index other indicator of data regarding hopping monitoring configuration aspects stored by UE 1015 (e.g., in hopping monitoring information 1048), hopping monitoring RF sensing logic 1046 may use the indication of hopping monitoring configuration to identify data for hopping monitoring configuration.

Although not expressly set forth in the example of flow 800 in FIG. 8, the UE may monitor a reference signal (e.g., a SRS, PRS, etc., as may be transmitted by a network configuring entity or another network entity) in accordance with the hopping monitoring configuration. Accordingly, UE 1015 may provide information regarding a reference signal monitored in accordance with the indication of hopping monitoring configuration to the network configuring entity and/or another network entity. For example, UE 1015 may transmit (e.g., via one or more of wireless radios 1001a-r operating under control of hopping monitoring RF sensing logic 1046), to one or more network configuring entity and/or another network entity. RF sensing information and/or other information with respect to monitoring a reference signal.

It is noted that one or more blocks (or operations) described with reference to FIGS. 7 and 8 may be combined with one or more blocks (or operations) described with reference to another of the figures. For example, one or more blocks (or operations) of FIG. 7 may be combined with one or more blocks (or operations) of FIG. 8. As another example, one or more blocks associated with FIG. 7 may be combined with one or more blocks associated with FIG. 3. As another example, one or more blocks associated with FIG. 8 may be combined with one or more blocks (or operations) associated with FIG. 3. Additionally, or alternatively, one or more operations described above with reference to FIGS. 1-3 may be combined with one or more operations described with reference to FIG. 9 or 10.

In one or more aspects, techniques for wireless communications may include additional aspects, such as any single aspect or any combination of aspects described below or in connection with one or more other processes or devices described elsewhere herein. In a first aspect, a method for wireless communication performed by a UE may include obtaining, by the UE from a network configuring entity, an indication of a hopping monitoring configuration for a reference signal. Additionally, an apparatus may be configured to perform or operate according to one or more aspects as described below. In some implementations, the apparatus includes a wireless device, such as a UE. In some implementations, the apparatus may include at least one transceiver, at least one processor, and a memory coupled to the processor. The processor may be configured to perform operations described herein with respect to the apparatus. In some other implementations, the apparatus may include a non-transitory computer-readable medium having program code recorded thereon and the program code may be executable by a processing system for causing the processing system to perform operations described herein with reference to the apparatus. In some implementations, the apparatus may include one or more means configured to perform operations described herein.

In a second aspect, alone or in combination with the first aspect, the hopping monitoring configuration comprises a sub-band baseband bandwidth hopping configuration providing a uniform sub-band frequency hopping pattern, and wherein the indication of the hopping monitoring configuration comprises an indication of a number of blocks, an inter-sub-band time, a number of subcarriers per sub-band, a carrier frequency per sub-band, an index value that identifies at least one of a plurality of predefined sub-band baseband bandwidth hopping patterns, or any combination thereof.

In a third aspect, alone or in combination with one or more of the first through the second aspects, the hopping monitoring configuration comprises a sub-band baseband bandwidth hopping configuration providing a non-uniform sub-band frequency hopping pattern, and wherein the indication of the hopping monitoring configuration comprises an indication a number of blocks, a hopping value for blocks, a number of sub-bands per block, subcarriers occupied by a sub-band, a bitmap assigning at least some combinations of subcarriers to the sub-band frequency hopping pattern, an index value that identifies at least one of a plurality of predefined sub-band baseband bandwidth hopping patterns, or any combination thereof.

In a fourth aspect, alone or in combination with one or more of the first through the third aspects, the method further includes transmitting, by the UE for the network configuring entity, an indication of capability regarding one or more capability of the UE for baseband frequency hopping.

In a fifth aspect, alone or in combination with one or more of the first through the fourth aspects, the hopping monitoring configuration comprises an antenna hopping configuration providing a subset of antenna resources for use by the UE for each orthogonal frequency division multiplexing (OFDM) symbol or sub-band of a baseband bandwidth of the hopping monitoring configuration.

In a sixth aspect, alone or in combination with one or more of the first through the fifth aspects, the hopping monitoring configuration comprises a sub-band baseband bandwidth hopping configuration, an antenna hopping configuration, or both.

In a seventh aspect, alone or in combination with one or more of the first through the sixth aspects, the hopping monitoring configuration comprises a sub-band baseband bandwidth hopping configuration providing a uniform sub-band frequency hopping pattern.

In an eighth aspect, alone or in combination with one or more of the first through the seventh aspects, the indication of the hopping monitoring configuration comprises an indication of a number of blocks, an inter-sub-band time, a number of subcarriers per sub-band, a carrier frequency per sub-band, or any combination thereof.

In a ninth aspect, alone or in combination with one or more of the first through the eighth aspects, the hopping monitoring configuration comprises a sub-band baseband bandwidth hopping configuration providing a non-uniform sub-band frequency hopping pattern.

In a tenth aspect, alone or in combination with one or more of the first through the ninth aspects, the indication of the hopping monitoring configuration comprises an indication of a number of blocks, a hopping value for blocks, a number of sub-bands per block, subcarriers occupied by a sub-band, or any combination thereof.

In an eleventh aspect, alone or in combination with one or more of the first through the tenth aspects, the indication of the hopping monitoring configuration comprises a bitmap assigning at least some combinations of subcarriers to the sub-band frequency hopping pattern.

In a twelfth aspect, alone or in combination with one or more of the first through the tenth aspects, the indication of the hopping monitoring configuration comprises an index value, wherein the index value identifies at least one of a plurality of predefined sub-band baseband bandwidth hopping patterns.

In a thirteenth aspect, alone or in combination with one or more of the first through the eleventh aspects, the network configuring entity comprises a network location management function (LMF), a network sensing management function (SnMF), a network node, or a second UE.

In a fourteenth aspect, alone or in combination with one or more of the first through the twelfth aspects, the indication of the hopping monitoring configuration is obtained by the UE in association with a request made from a network location management function (LMF), a network sensing management function (SnMF), a network node, or the UE.

In a fifteenth aspect, alone or in combination with one or more of the first through the thirteenth aspects, the method further includes providing, for the network configuring entity, an indication of capability regarding one or more capability of the UE for baseband frequency hopping.

In a sixteenth aspect, alone or in combination with one or more of the first through the fourteenth aspects, the indication of capability comprises a minimum time for the UE to implement frequency hopping between two transmissions, a minimum time for the UE to implement frequency hopping between two receptions, or a combination thereof.

In a seventeenth aspect, alone or in combination with one or more of the first through the fifteenth aspects, the hopping monitoring configuration comprises an antenna hopping configuration providing a subset of antenna resources for use by the UE for each orthogonal frequency division multiplexing (OFDM) symbol or sub-band of a baseband bandwidth of the hopping monitoring configuration.

In an eighteenth aspect, alone or in combination with one or more of the first through the sixteenth aspects, the antenna hopping configuration provides uniform partitioning of the antenna resources.

In a nineteenth aspect, alone or in combination with one or more of the first through the seventeenth aspects, the antenna hopping configuration provides non-uniform partitioning of the antenna resources.

In one or more aspects, techniques for supporting wireless communication may include additional aspects, such as any single aspect or any combination of aspects described below or in connection with one or more other processes or devices described elsewhere herein. In a twentieth aspect, supporting wireless communications may include a method for wireless communication performed by a network configuring entity, the method comprising determining a hopping monitoring configuration for a reference signal; and providing, for one or more user equipments (UEs), an indication of the hopping monitoring configuration. Additionally, an apparatus may be configured to perform or operate according to one or more aspects as described below. In some implementations, the apparatus includes a wireless device, such as a network configuring entity. In some implementations, the apparatus may include at least one transceiver, a processing system comprising at least one processor, and a memory coupled to the processing system. The processing system may be configured to perform operations described herein with respect to the apparatus. In some other implementations, the apparatus may include a non-transitory computer-readable medium having program code recorded thereon and the program code may be executable by a processing system for causing the processing system to perform operations described herein with reference to the apparatus. In some implementations, the apparatus may include one or more means configured to perform operations described herein. n may include one or more operations described herein with reference to the apparatus.

In a twenty-first aspect, in combination with the twentieth aspect, the hopping monitoring configuration comprises a sub-band baseband bandwidth hopping configuration providing a uniform sub-band frequency hopping pattern, and wherein the indication of the hopping monitoring configuration comprises an indication of a number of blocks, an inter-sub-band time, a number of subcarriers per sub-band, a carrier frequency per sub-band, or any combination thereof.

In a twenty-second aspect, in combination with one or more of the twentieth through twenty-first aspects, the hopping monitoring configuration comprises a sub-band baseband bandwidth hopping configuration providing a non-uniform sub-band frequency hopping pattern, and wherein the indication of the hopping monitoring configuration comprises an indication of a number of blocks, a hopping value for blocks, a number of sub-bands per block, subcarriers occupied by a sub-band, or any combination thereof.

In a twenty-third aspect, in combination with one or more of the twentieth through twenty-second aspects, the hopping monitoring configuration comprises a sub-band baseband bandwidth hopping configuration providing a non-uniform sub-band frequency hopping pattern, and wherein the indication of the hopping monitoring configuration comprises a bitmap assigning at least some combinations of subcarriers to the sub-band frequency hopping pattern.

In a twenty-fourth aspect, in combination with one or more of the twentieth through twenty-third aspects, the indication of the hopping monitoring configuration comprises an index value, wherein the index value identifies at least one of a plurality of predefined sub-band baseband bandwidth hopping patterns.

In a twenty-fifth aspect, in combination with one or more of the twentieth through twenty-fourth aspects, the network configuring entity comprises a network location management function (LMF), a network sensing management function (SnMF), a network node, or a UE other than the one or more UEs.

In a twenty-sixth aspect, in combination with one or more of the twentieth through twenty-fifth aspects, the indication of the hopping monitoring configuration is obtained by a UE of the one or more UEs in association with a request made from a network location management function (LMF), a network sensing management function (SnMF), a network node, or the UE.

In a twenty-seventh aspect, in combination with one or more of the twentieth through twenty-sixth aspects, the method further includes obtaining, from a UE of the one or more UEs, an indication.

In a twenty-eighth aspect, in combination with one or more of the twentieth through twenty-seventh aspects, the hopping monitoring configuration comprises an antenna hopping configuration providing a subset of antenna resources for use by the one or more UEs for each orthogonal frequency division multiplexing (OFDM) symbol or sub-band of a baseband bandwidth of the hopping monitoring configuration.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-3, and 9 and 10 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A user equipment (UE) comprising:
a processing system that includes one or more processors and one or more memories coupled with the one or more processors, the processing system configured to cause the UE to:
obtain, from a network configuring entity, an indication of a hopping monitoring configuration for a reference signal; and
configure processing for the reference signal according to the indication of the hopping monitoring configuration.

2. The UE of claim 1, wherein the hopping monitoring configuration comprises a sub-band baseband bandwidth hopping configuration, an antenna hopping configuration, or both.

3. The UE of claim 1, wherein the hopping monitoring configuration comprises a sub-band baseband bandwidth hopping configuration providing a uniform sub-band frequency hopping pattern.

4. The UE of claim 3, wherein the indication of the hopping monitoring configuration comprises an indication of a number of blocks, an inter-sub-band time, a number of subcarriers per sub-band, a carrier frequency per sub-band, or any combination thereof.

5. The UE of claim 1, wherein the hopping monitoring configuration comprises a sub-band baseband bandwidth hopping configuration providing a non-uniform sub-band frequency hopping pattern.

6. The UE of claim 5, wherein the indication of the hopping monitoring configuration comprises an indication of a number of blocks, a hopping value for blocks, a number of sub-bands per block, subcarriers occupied by a sub-band, or any combination thereof.

7. The UE of claim 5, wherein the indication of the hopping monitoring configuration comprises a bitmap assigning at least some combinations of subcarriers to the sub-band frequency hopping pattern.

8. The UE of claim 1, wherein the indication of the hopping monitoring configuration comprises an index value, wherein the index value identifies at least one of a plurality of predefined sub-band baseband bandwidth hopping patterns.

9. The UE of claim 1, wherein the network configuring entity comprises a network location management function (LMF), a network sensing management function (SnMF), a network node, or a second UE.

10. The UE of claim 1, wherein the indication of the hopping monitoring configuration is obtained by the UE in association with a request made from a network location management function (LMF), a network sensing management function (SnMF), a network node, or the UE.

11. The UE of claim 1, the processing system is further configured to cause the UE to:
provide, for the network configuring entity, an indication of capability regarding one or more capability of the UE for baseband frequency hopping.

12. The UE of claim 11, wherein the indication of capability comprises a minimum time for the UE to implement frequency hopping between two transmissions, a minimum time for the UE to implement frequency hopping between two receptions, or a combination thereof.

13. The UE of claim 1, wherein the hopping monitoring configuration comprises an antenna hopping configuration providing a subset of antenna resources for use by the UE for each orthogonal frequency division multiplexing (OFDM) symbol or sub-band of a baseband bandwidth of the hopping monitoring configuration.

14. The UE of claim 13, wherein the antenna hopping configuration provides uniform partitioning of the antenna resources.

15. The UE of claim 13, wherein the antenna hopping configuration provides non-uniform partitioning of the antenna resources.

16. A method of wireless communication performed by a user equipment (UE), the method comprising:
obtaining, by the UE from a network configuring entity, an indication of a hopping monitoring configuration for a reference signal; and
configuring, by the UE, processing for the reference signal according to the indication of the hopping monitoring configuration.

17. The method of claim 16, wherein the hopping monitoring configuration comprises a sub-band baseband bandwidth hopping configuration providing a uniform sub-band frequency hopping pattern, and wherein the indication of the hopping monitoring configuration comprises an indication of a number of blocks, an inter-sub-band time, a number of subcarriers per sub-band, a carrier frequency per sub-band, an index value that identifies at least one of a plurality of predefined sub-band baseband bandwidth hopping patterns, or any combination thereof.

18. The method of claim 16, wherein the hopping monitoring configuration comprises a sub-band baseband bandwidth hopping configuration providing a non-uniform sub-band frequency hopping pattern, and wherein the indication of the hopping monitoring configuration comprises an indication a number of blocks, a hopping value for blocks, a number of sub-bands per block, subcarriers occupied by a sub-band, a bitmap assigning at least some combinations of subcarriers to the sub-band frequency hopping pattern, an index value that identifies at least one of a plurality of predefined sub-band baseband bandwidth hopping patterns, or any combination thereof.

19. The method of claim 16, further comprising:
transmitting, by the UE for the network configuring entity, an indication of capability regarding one or more capability of the UE for baseband frequency hopping.

20. The method of claim 16, wherein the hopping monitoring configuration comprises an antenna hopping configuration providing a subset of antenna resources for use by the UE for each orthogonal frequency division multiplexing (OFDM) symbol or sub-band of a baseband bandwidth of the hopping monitoring configuration.

21. A network configuration entity comprising:
a processing system that includes one or more processors and one or more memories coupled with the one or more processors, the processing system configured to cause the network configuration entity to:
determine a hopping monitoring configuration for a reference signal; and
provide, for one or more user equipments (UEs), an indication of the hopping monitoring configuration.

22. The network configuration entity of claim 21, wherein the hopping monitoring configuration comprises a sub-band baseband bandwidth hopping configuration providing a uniform sub-band frequency hopping pattern, and wherein the indication of the hopping monitoring configuration comprises an indication of a number of blocks, an inter-sub-band time, a number of subcarriers per sub-band, a carrier frequency per sub-band, or any combination thereof.

23. The network configuration entity of claim 21, wherein the hopping monitoring configuration comprises a sub-band baseband bandwidth hopping configuration providing a non-uniform sub-band frequency hopping pattern, and wherein the indication of the hopping monitoring configuration comprises an indication of a number of blocks, a hopping value for blocks, a number of sub-bands per block, subcarriers occupied by a sub-band, or any combination thereof.

24. The network configuration entity of claim 21, wherein the hopping monitoring configuration comprises a sub-band baseband bandwidth hopping configuration providing a non-uniform sub-band frequency hopping pattern, and wherein the indication of the hopping monitoring configuration comprises a bitmap assigning at least some combinations of subcarriers to the sub-band frequency hopping pattern.

25. The network configuration entity of claim 21, wherein the indication of the hopping monitoring configuration comprises an index value, wherein the index value identifies at least one of a plurality of predefined sub-band baseband bandwidth hopping patterns.

26. The network configuration entity of claim 21, wherein the network configuring entity comprises a network location management function (LMF), a network sensing management function (SnMF), a network node, or a UE other than the one or more UEs.

27. The network configuration entity of claim 21, wherein the indication of the hopping monitoring configuration is obtained by a UE of the one or more UEs in association with a request made from a network location management function (LMF), a network sensing management function (SnMF), a network node, or the UE.

28. The network configuration entity of claim 21, the processing system is further configured to cause the network configuration entity to:
obtain, from a UE of the one or more UEs, an indication of capability regarding one or more capability of the UE for baseband frequency hopping.

29. The network configuration entity of claim 21, wherein the hopping monitoring configuration comprises an antenna hopping configuration providing a subset of antenna resources for use by the one or more UEs for each orthogonal frequency division multiplexing (OFDM) symbol or sub-band of a baseband bandwidth of the hopping monitoring configuration.

30. A method of wireless communication performed by a network configuration entity, the method comprising:
determining a hopping monitoring configuration for a reference signal; and
providing, for one or more user equipments (UEs), an indication of the hopping monitoring configuration.
